(19) United States
(12) Patent Application Publication
(10) Pub. No.: US 2013/0063816 A1
(43) Pub. Date: Mar. 14, 2013

(54) VIEWING AID FOR STEREOSCOPIC 3D DISPLAY

(71) Applicant: John Reidar Mathiassen, Trondheim (NO)

(72) Inventor: John Reidar Mathiassen, Trondheim (NO)

(21) Appl. No.: 13/699,109

(22) PCT Filed: Jun. 28, 2011
(86) PCT No.: PCT/EP2011/060792

§ 371 Date: Nov. 20, 2012

(30) Foreign Application Priority Data
Jun. 28, 2010 (NO) 20100935

(51) Int. Cl. G02B 27/22

(52) U.S. Cl. 359/464

(57) ABSTRACT

This invention relates to a stereoscopic viewing aid for viewing images received from a stereoscopic imaging system, the imaging system comprising two channels providing images having two different sets of wavelength ranges, the viewing aid comprising two filtering means, the first transmitting light within the first set of wavelengths and the second transmitting light within the second set of wavelengths, each of said filtering means comprising a first optical device having a selected focal length at the corresponding wavelengths.

### FIELD OF THE INVENTION

The present invention relates generally to eyewear used as a viewing aid for stereoscopic 3D displays, and more particularly to eyewear used for viewing stereoscopic 3D displays based on wavelength-division multiplexing.

### BACKGROUND OF THE INVENTION

Several different methods exist for providing stereoscopic 3D images when viewing displays, such as shutter glasses where the two images are shown in a sequence and a shutter is placed in the glasses determining which image is to be shown to which eye, and polarizing glasses and projectors or screens where the glasses only transmits the right or left image to the corresponding eye. The disadvantage with shutter glasses requires that the glasses are active (requiring batteries), are dark (visible light transmission of 20%) and have a limited refresh rate. The disadvantages of polarizing glasses are the need for polarization retention in the screen, making it difficult to obtain a high stereo extinction ratio, and the relatively low visible light transmission (40-45%) in the glasses. A more promising method, herein called the “Infitec” method or approach, is discussed in multiple references (U.S. Pat. No. 7,001,021 B2, EP 1 830 585 A2, WO 2004/038457 A2, WO 2008/061511 A1, WO 2009/026888 A1), as well as in the referenced articles “LED-Based 3D Displays with Infitec Technology” and “Interference-Filter-Based Stereoscopic 3D LCD”. The Infitec approach to stereoscopic 3D displays uses interference filters for wavelength-division multiplexing in the display and demultiplexing in the glasses. Infitec has several good properties, including passive glasses, the use of standard projection screens and an excellent stereo extinction ratio. Wavelength-division multiplexing stereoscopic 3D displays of both the projection type and transmissive types exist in the prior art (see references). However, the filters used in Infitec approach, and other similar solutions, are angle-sensitive. This angle dependency puts big constraints on the design of the eyewear, since the angle-of-incidence of incident light must be as close to perpendicular as possible for all viewing directions. In the prior art, this problem is circumvented by having curved lenses at a distance from the eye (US 2007/0236809 A1, US 2008/0278807 A1) or flat lenses with a narrow field of view. Some prior art include large guard bands between the left-eye transmission spectrum and right-eye transmission spectrum, in order to compensate for the angle-dependent shift of the transmission spectrum in the glasses. The angle dependency leads to design choices with loss of display brightness, color distortions when viewing off-screen objects and a reduced common color gamut between the left-eye image and right-eye image. The angle dependency of the Infitec interference filters further constrains the location of the filters in the optical path of the display or projector. A further disadvantage of the Infitec approach is the relatively high cost of the glasses, compared to glasses used with polarization-based stereoscopic 3D displays. The high cost of the prior art Infitec glasses is due to the high number of dielectric layers required—on the order of 50-100 layers—to obtain a high stereo extinction ratio. The cost of coating glasses with interference filters is roughly proportional to the number of dielectric layers and the combined thickness of all these layers, and thus the large number of layers results in a high cost for the glasses. Thus, there is a need for a viewing aid for stereoscopic 3D displays that enables greater freedom in the design of the display/projector and viewing aid, while retaining the good properties of the Infitec method and reducing or removing the disadvantages discussed above.

### SUMMARY OF THE INVENTION

It is an objective of the present invention to provide improvements to the prior art in eyewear used as a viewing aid for stereoscopic 3D displays, in particular for such displays using wavelength-division multiplexing. It is a further objective of the present invention to provide improvements to the prior art in stereoscopic 3D displays in general. These objectives are obtained with eyewear as described above and characterized as defined in the independent claims.

The present invention provides eyewear for viewing a stereoscopic 3D display, where said display uses wavelength-division multiplexing. The present invention provides optical assemblies in the eyewear for wavelength-selective filtering. In exemplary embodiments of the present invention, both the display and optical assemblies in the eyewear include thin-film interference filters, rugate notch filters or holographic notch filters. These filter types have transmission spectra that are highly dependent on the angle-of-incidence to the filters. This angle dependency is a problem in the prior art, and puts severe constraints on both the eyewear design and the location of the filters in the optical path of the display or projector. Exemplary embodiments of the present invention provide eyewear that ensures that the angle-of-incidence to the filters in the eyewear is as close to perpendicular (0 degrees incidence) as possible, thus avoiding some of the problems of the prior art for stereoscopic 3D displays using such filters in the eyewear. A second problem in the prior art is the need for a high stereo extinction ratio in the eyewear filters, and thus the need for a large number of dielectric layers in the filters. This problem is due to both left-eye and right-eye images being equally focused when viewing said images through both lenses of the eyewear. Exemplary embodiments of the present invention provide eyewear with wavelength-selective defocusing of the left-eye image in the right-eye lens of the eyewear and of the right-eye image in the left-eye lens of the eyewear. By means of wavelength-selective defocusing of the complementary image, the perceived image quality of the left-eye and right-eye images—and the stereoscopically fused image pair—can be high, even with a lower stereo extinction ratio than used in the prior art.

In an exemplary embodiment of the present invention, the eyewear is suitable for viewing a stereoscopic 3D front-projection display. In another exemplary embodiment of the present invention, the eyewear is suitable for viewing a stereoscopic 3D transmissive flat-panel display with an edge-lit backlighting unit (BLU) using narrow-band LED or laser illumination.

The present invention thus is an improvement over the Infitec approach, by reducing the angle-dependency of the transmission spectra of the eyewear, and by reducing the need for very many layers in the filters. The present invention further improves the prior art by enabling greater design freedom with respect to choosing display and eyewear filter sets with increased brightness, larger color gamut, higher visible light transmission and less color distortions.

### BRIEF DESCRIPTION OF THE DRAWINGS

The invention will now be described with reference to the accompanying figures, illustrating the invention by way of examples, in which:

FIG. 1 shows a block diagram of a stereoscopic 3D display; and

FIG. 2 shows a block diagram of a display unit of the projection display; and

FIG. 3 shows a block diagram of a display unit of the backlit transmissive display type; and

FIG. 4 shows a block diagram of a stereo illumination unit used in the stereoscopic 3D projection display system of FIG. 2 and in the stereoscopic 3D backlit transmissive display system of FIG. 3; and

FIG. 5 shows a diagram of the control signals for the stereo illumination unit of FIG. 4; and

FIG. 6 shows the relationship between the display unit imaging surface and the viewing aid, according to an exemplary embodiment of the present invention; and

FIG. 7 shows transmission spectra of the illumination combiner and viewing aid, according to an exemplary embodiment of the present invention; and

FIG. 8 shows transmission spectra of the illumination combiner and viewing aid, according to an exemplary embodiment of the present invention; and

FIG. 9 shows a photograph of prior art wavelength-demultiplexing glasses of the Infitec type; and

FIG. 10 shows a schematic illustration of the lenses of the prior art; and

FIG. 11 shows the lens assembly, being of a flat type, of the lenses of the eyewear illustrated in FIG. 6, according to an exemplary embodiment of the present invention; and

FIG. 12 shows the lens assembly, being of a curved type, of the lenses of the eyewear illustrated in FIG. 6, according to an exemplary embodiment of the present invention; and

FIG. 13 shows the operation of a region of the lens assembly of the lenses of the eyewear illustrated in FIG. 6, according to an exemplary embodiment of the present invention; and

FIG. 14 shows the use of two Fresnel lenses in the lens assembly of FIG. 11, according to an exemplary embodiment of the present invention; and

FIG. 15 shows the use of two Fresnel lenses in the lens assembly of FIG. 11, according to an exemplary embodiment of the present invention; and

FIG. 16 shows the use of two Fresnel lenses in the lens assembly of FIG. 11, according to an exemplary embodiment of the present invention; and

FIG. 17 shows the use of two Fresnel lenses in the lens assembly of FIG. 11, according to an exemplary embodiment of the present invention; and

FIG. 18 shows the use of two diffractive lenses in the lens assembly of FIG. 11, according to an exemplary embodiment of the present invention; and

FIG. 19 shows the use of two diffractive lenses in the lens assembly of FIG. 11, according to an exemplary embodiment of the present invention; and

FIG. 20 shows the use of two diffractive lenses in the lens assembly of FIG. 11, according to an exemplary embodiment of the present invention; and

FIG. 21 shows the transmission spectrum of display filters included in an example filter set, according to an exemplary embodiment of the present invention; and

FIG. 22 shows the diffraction efficiency of a first multi-order diffractive lens included in an example lens set, according to an exemplary embodiment of the present invention; and

FIG. 23 shows the diffraction efficiency of a second multi-order diffractive lens included in an example lens set, according to an exemplary embodiment of the present invention; and

FIG. 24 shows the transmission spectrum of the left-eye display filter and right-eye eyewear filter, included in an example filter set, according to an exemplary embodiment of the present invention; and

FIG. 25 shows the transmission spectrum of the right-eye display filter and left-eye eyewear filter, included in an example filter set, according to an exemplary embodiment of the present invention; and

The following reference numerals are used in the specification and drawings:

| Number | Name | Context |
|---|---|---|
| 10 | Stereoscopic 3D display | |
| | system | |
| 11 | Left-eye image data | In stereoscopic 3D display system 10 |
| 12 | Right-eye image data | In stereoscopic 3D display system 10 |
| 13 | Display unit | In stereoscopic 3D display system 10 |
| 14 | Eyewear | In stereoscopic 3D display system 10 |
| 15 | Left eye | In stereoscopic 3D display system 10 |
| 16 | Right eye | In stereoscopic 3D display system 10 |
| 101 | Stereo illumination unit | In display unit 13 |
| 102 | Illumination optics | In projection-display embodiments of display |
| | | unit 13 |
| 103 | Spatial light modulator(s) | In projection-display embodiments of display |
| | | unit 13 |
| 104 | Projection optics | In projection-display embodiments of display |
| | | unit 13 |
| 105 | Screen surface | In projection-display embodiments of display |
| | | unit 13 |
| 112 | Backlight illumination optics | In transmissive-display embodiments of |
| | | display unit 13 |
| 113 | Transmissive display panel | In transmissive-display embodiments of |
| | | display unit 13 |
| 201 | Left-eye illumination source | In stereo illumination unit 101 |
| 202 | Right-eye illumination | In stereo illumination unit 101 |
| | source | |
| 203 | Illumination combiner | In stereo illumination unit 101 |
| 221 | Left-eye illumination source | Control signal for left-eye illumination source |
| | control signal | 201 |
| 222 | Right-eye illumination | Control signal for right-eye illumination source |
| | source control signal | 202 |
| 130 | Display unit imaging surface | Imaging surface of display unit 13 |
| 2100 | Spatial imaging element | Small spatial region of display unit imaging |
| | | surface 130 |
| 2101 | Left-eye targeted light ray | Light ray bundle from spatial imaging element |
| | bundle | 2100 to left eye 15 |
| 2102 | Right-eye targeted light ray | Light ray bundle from spatial imaging element |
| | bundle | 2100 to right eye 16 |
| 2001 | Left-eye lens | Lens over left-eye portion of eyewear 14 |
| 2002 | Right-eye lens | Lens over right-eye portion of eyewear 14 |
| 1501 | Left-eye illumination | Transmission spectrum of left-eye illumination |
| | combiner transmission | through illumination combiner 203 |
| | spectrum | |
| 1502 | Right-eye illumination | Transmission spectrum of right-eye |
| | combiner transmission | illumination through illumination combiner |
| | spectrum | 203 |
| 2401 | Left-eye lens transmission | Transmission spectrum of left-eye lens 2001 |
| | spectrum | |
| 2402 | Right-eye lens transmission | Transmission spectrum of right-eye lens 2002 |
| | spectrum | |
| 2201 | Flat lens | Prior art flat lens of the Infitec type |
| 2210 | Filter | Filter of flat lens 2201 |
| 2220 | Filter substrate | Filter substrate of flat lens 2201 |
| 2202 | Curved lens | Prior art curved lens of the Infitec type |
| 2230 | Filter | Filter of curved lens 2202 |
| 2240 | Filter substrate | Filter substrate of curved lens 2202 |
| 2000 | Lens assembly | In left-eye lens 2001 and right-eye lens 2002 |
| 2010 | Outer optical assembly | In lens assembly 2000 |
| 2005 | Geometrical surface | In lens assembly 2000 |
| 2020 | Filter | In embodiment of lens assembly 2000 |
| 2030 | Inner optical assembly | In lens assembly 2000 |
| 2040 | Eye pupil | In illustration of operation of lens assembly |
| | | 2000 |
| 2050 | Entry light ray | In illustration of operation of lens assembly |
| | | 2000 |
| 2055 | Corrected light ray | In illustration of operation of lens assembly |
| | | 2000 |
| 2070 | Exit light ray | In illustration of operation of lens assembly |
| | | 2000 |
| 2080 | Exit light ray angle | In illustration of operation of lens assembly |
| | | 2000 |
| 2095 | Distortion offset | In illustration of operation of lens assembly |
| | | 2000 |
| 2011 | Outer Fresnel lens | In embodiment of lens assembly 2000 |
| 2021 | Filter substrate | In embodiment of lens assembly 2000 |
| 2031 | Inner Fresnel lens | In embodiment of lens assembly 2000 |
| 2140 | Low-index layer | In embodiment of lens assembly 2000 |
| 2150 | Lens substrate | In embodiment of lens assembly 2000 |
| 2311 | Outer lens substrate | In embodiment of lens assembly 2000 |
| 2312 | Outer diffractive surface | In embodiment of lens assembly 2000 |
| 2322 | Inner diffractive surface | In embodiment of lens assembly 2000 |
| 2321 | Inner lens substrate | In embodiment of lens assembly 2000 |

### DETAILED DESCRIPTION OF THE INVENTION

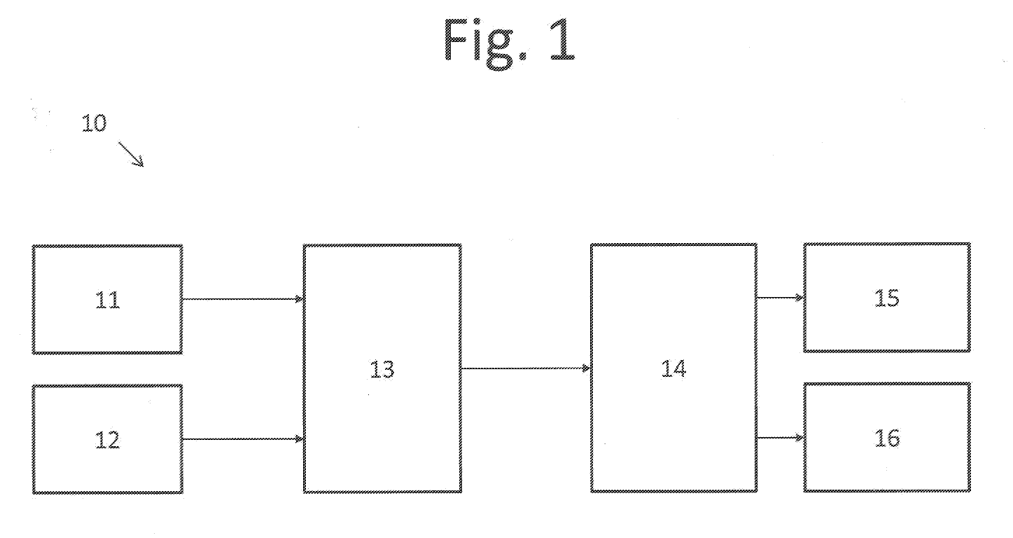

A general illustration of a stereoscopic 3D display system 10 shown in FIG. 1. Left image data 11 and right image data 12 are input to display unit 13. Display unit 13 displays the left image data 11 and right image data 12 onto the same or substantially the same spatial imaging grid by means of wavelength- and time-division multiplexing. Eyewear 14 performs wavelength-selective filtering, ensuring that the left eye 15 observes the left image data 11 and the right eye 16 observes the right image data 12.

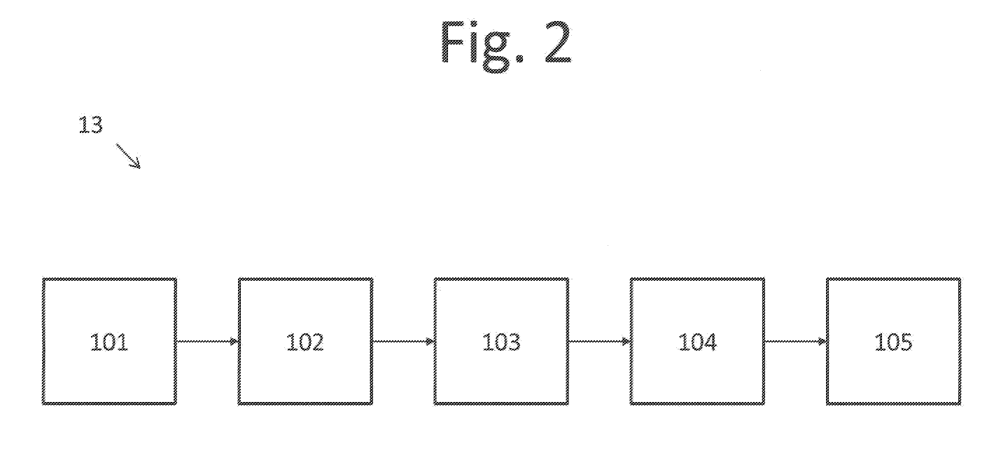

In one embodiment of the present invention, the display unit 13 is a projection display. A display unit 13 of the projection display type is illustrated in FIG. 2. A stereo illumination unit 101 performs wavelength- and time-division multiplexing of the illumination. Illumination optics 102 images the illumination onto one or more spatial light modulators 103. Projection optics 104 images the surface of one or more spatial light modulators 103 onto the projection screen 105.

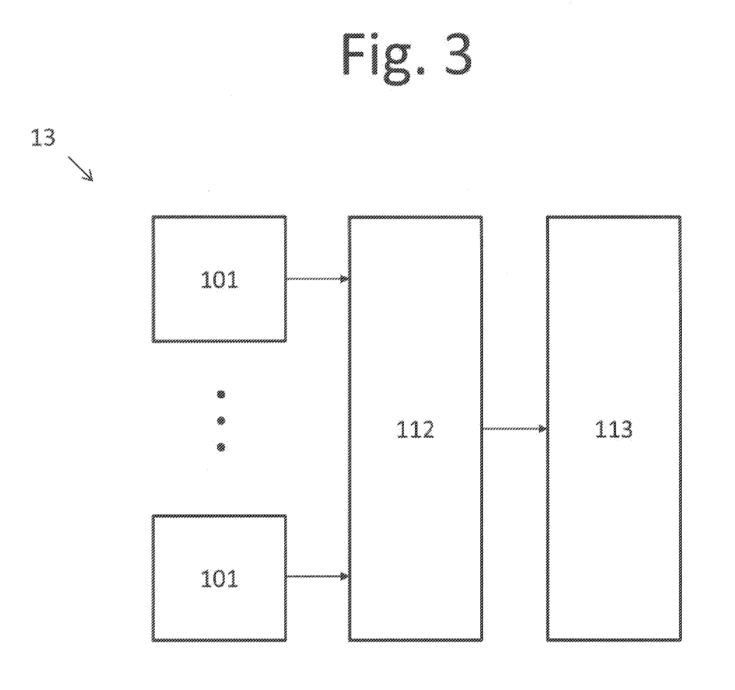

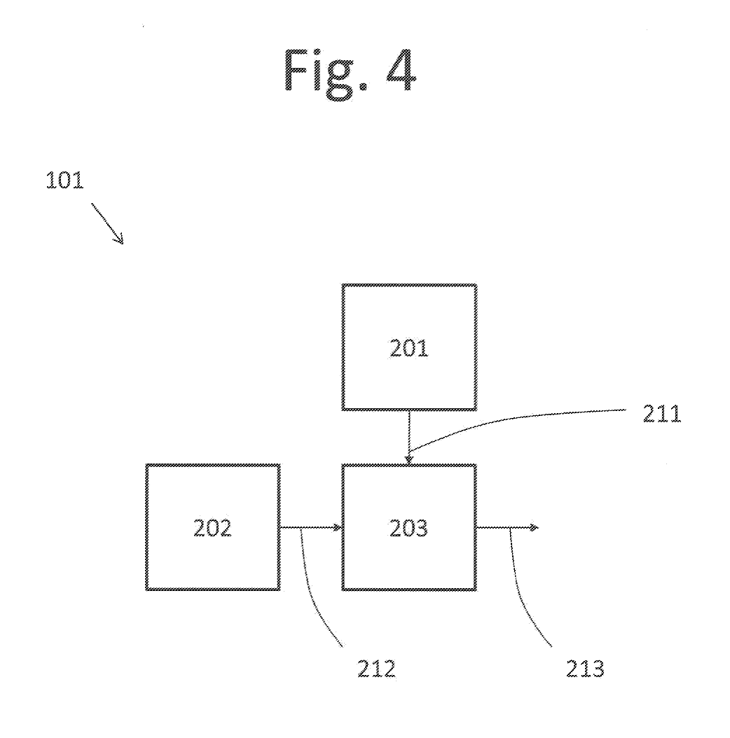

The display unit 13 may alternatively be a backlit transmissive display. A display unit 13 of the backlit transmissive type is illustrated in FIG. 3. One or more stereo illumination units 101 perform wavelength- and time-division multiplexing of the illumination. Backlight illumination optics 112 ensures that the illumination from stereo illumination units 101 is delivered to the rear of the transmissive display panel 113. An exemplary embodiment of a stereo illumination unit 101 is illustrated in FIG. 4. Stereo illumination unit 101 performs wavelength- and time-division multiplexing of the illumination. A left-eye illumination source 201 delivers left-eye illumination 211 to illumination combiner 203. A right-eye illumination source 202 delivers right-eye illumination 212 to the illumination combiner 203. The illumination combiner 203 delivers left-eye illumination 211 and right-eye illumination 212 to the output illumination 213 ensuring that output illumination 213 has the same or substantially the same etendue as the left-eye illumination 211 and right-eye illumination 212. Illumination optics 102 images the output illumination 213 onto one or more spatial light modulators 103 as indicated in FIG. 2.

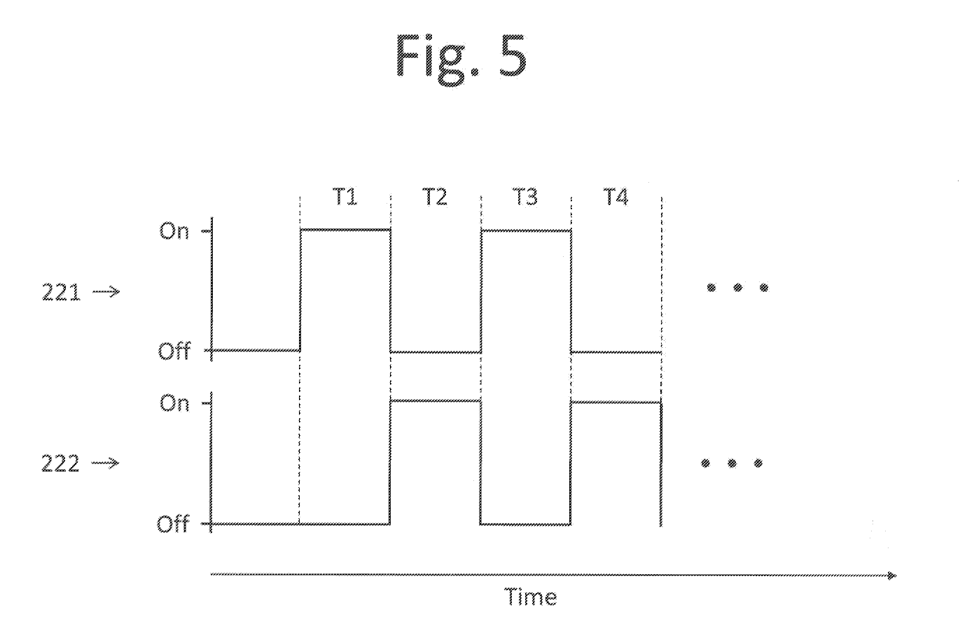

Control signals to left-eye illumination source 201 and right-eye illumination source 202, are illustrated in FIG. 5, showing a time multiplexed solution. Left-eye illumination control signal 221 controls the emission of left-eye illumination 211 from left-eye illumination source 201. Right-eye illumination control signal 222 controls the emission of right-eye illumination 212 from right-eye illumination source 202. The left-eye illumination source 201 and right-eye illumination source 202 may preferably be individually controllable. The time-division multiplexing of said two illumination sources is done by setting the control signals 221 and 222 such that in any one time period substantially only one of the illumination sources 201 or 202 emits illumination. In FIG. 5 this time-division multiplexing is illustrated, for 4 time intervals T1, T2, T3 and T4, by left-eye illumination control signal 221 being in the ‘on’ state in time intervals T1 and T3 and right-eye illumination control signal being ‘off’ in these two time intervals, and by right-eye illumination control signal 222 being in the ‘on’ state in time intervals T2 and T4 and left-eye illumination control signal being ‘off’ in these two time intervals. Time-division multiplexing of the display of left image data 11 and right image data 12 is preferably achieved by display unit 13 displaying the left image data 11 in time intervals in which left-eye illumination control signal 221 is in the ‘on’ state and by display unit 13 displaying right image data 12 in time intervals in which right-eye illumination control signal 222 is in the ‘on’ state. Display unit 13 may display substantially only left image data 11 during time intervals in which left-eye illumination control signal 221 is in the ‘on’ state, and display substantially only right image data 12 during time intervals in which right-eye illumination control signal 222 is in the ‘on’ state. By way of example, there may be commonalities between left image data 11 and right image data 12, and in said example there may be time intervals in which both left-eye illumination control signal 221 and right-eye illumination control signal 222 are in the ‘on’ state, and in said time intervals the common image data between left image data 11 and right image data 12 may be displayed, with the advantage of said example being an increased duty cycle of both illumination sources and thus increased displayed brightness.

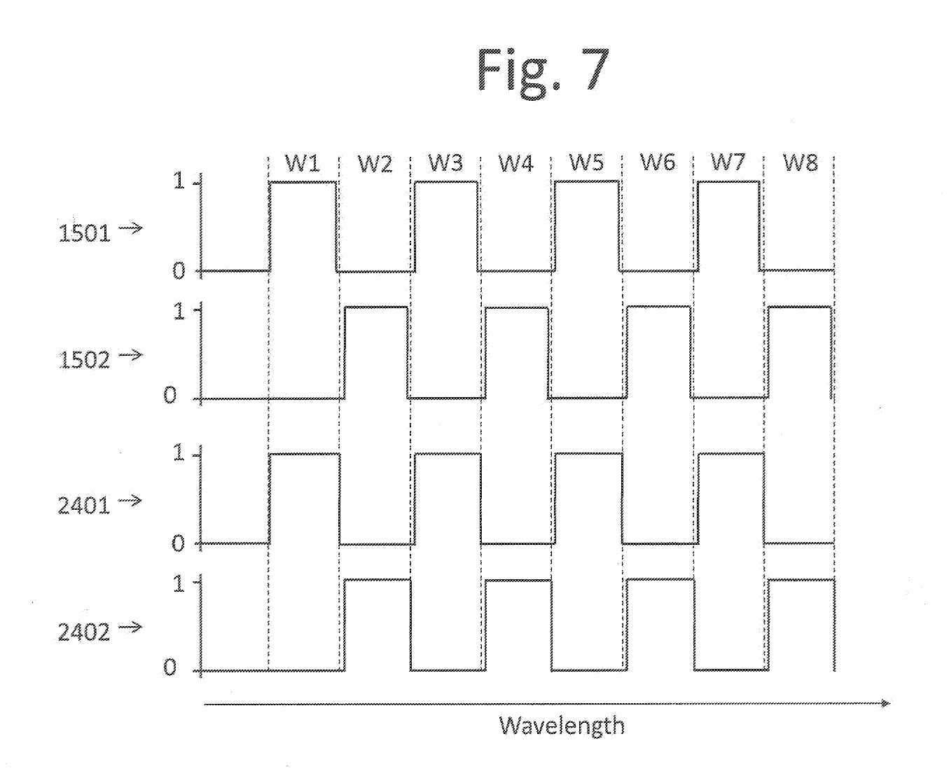

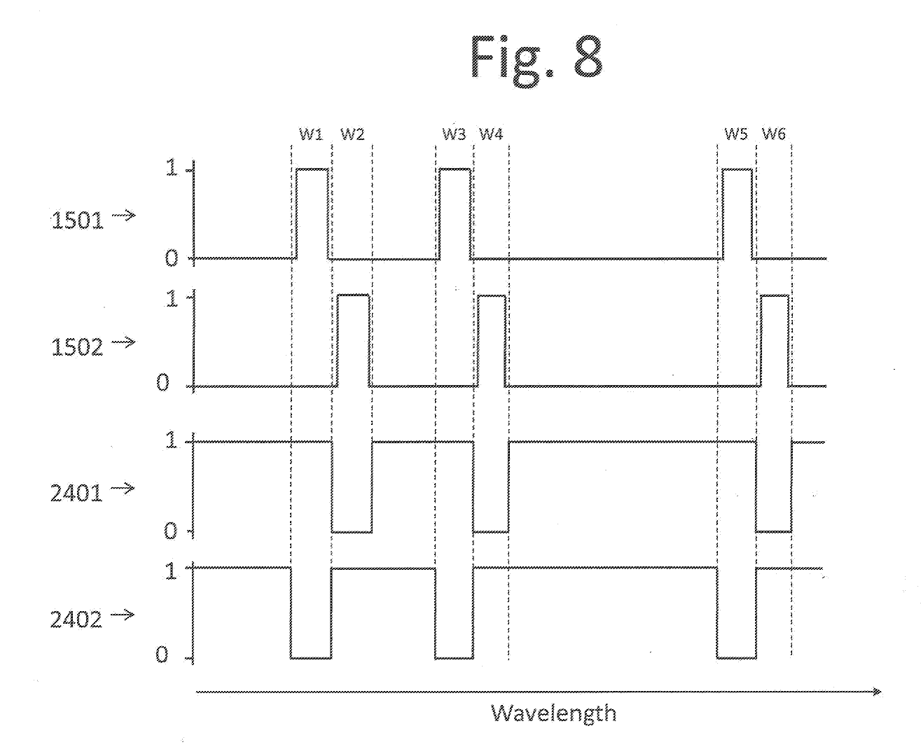

Referring to FIG. 7 and FIG. 8, a wavelength-division multiplexing in stereo illumination unit 101 can be characterized by the left-eye illumination combiner transmission spectrum 1501 seen by the left-eye illumination 211 as it passes through illumination combiner 203 and is wavelength-multiplexed into the output illumination 213, and similarly characterized by the right-eye illumination combiner transmission spectrum 1502 seen by the right-eye illumination 212 as it passes through illumination combiner 203 and is wavelength-multiplexed into the output illumination 213. Thus, when left-eye illumination control signal 221 is in the ‘on’ state and right-eye illumination control signal 222 is in the ‘off’ state, the spectrum of output illumination 213 of stereo illumination unit 101 is exactly or approximately equal to the spectrum of left-eye illumination 211 multiplied by the left-eye illumination combiner transmission spectrum 1501. Thus similarly, when right-eye illumination control signal 222 is in the ‘on’ state and left-eye illumination control signal 221 is in the ‘off’ state, the spectrum of output illumination 213 of stereo illumination unit 101 is exactly or approximately equal to the emission spectrum of left-eye illumination 212 multiplied by the right-eye illumination combiner transmission spectrum 1502.

The corresponding wavelength-selective filtering in eyewear 14 can be characterized by the left-eye lens transmission spectrum 2401 of left-eye lens 2001 of eyewear 14, and similarly characterized by the right-eye lens transmission spectrum 2402 of right-eye lens 2002 of eyewear 14. Example embodiments of left-eye eyewear transmission spectrum 2401 and the right-eye lens transmission spectrum 2402 are also illustrated in FIG. 7 and FIG. 8. These two figures will be explained in a following paragraph.

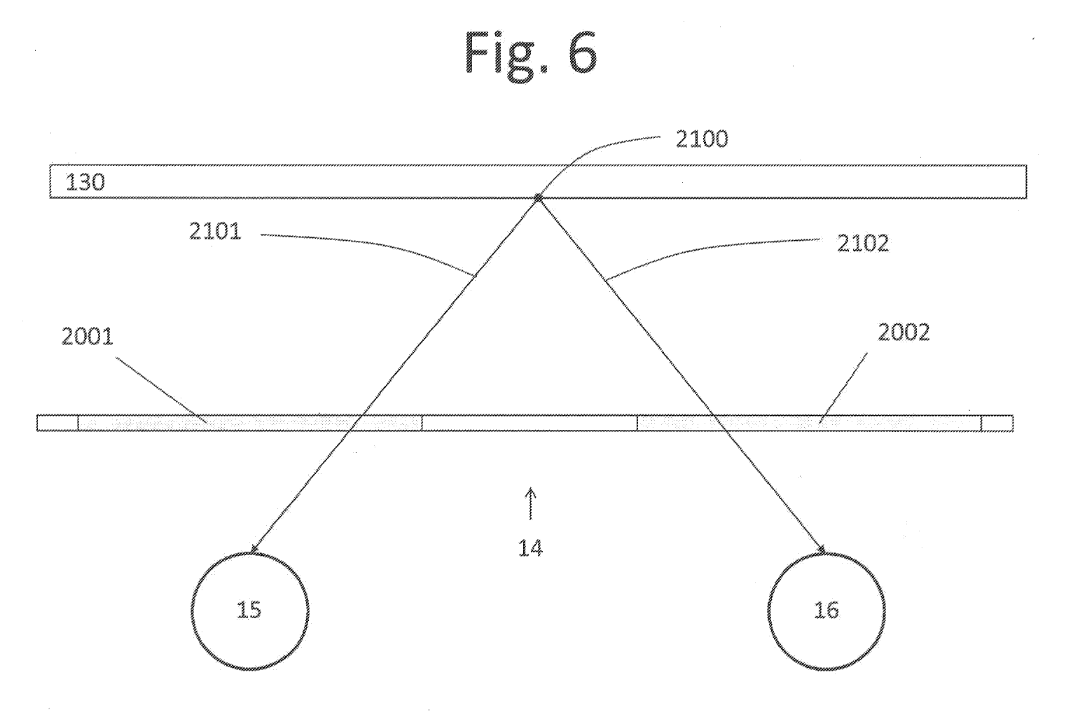

The operation of the stereoscopic 3D display system 10 can be illustrated as in FIG. 6. The display unit imaging surface 130 is the imaging surface of display unit 13. In a projection display embodiment of display unit 13, the display unit imaging surface 130 may be a front- or rear-projection projection screen. In a backlit transmissive display embodiment of display unit 13, the display unit imaging surface 130 may be the visible surface of a transmissive display panel 113. A spatial imaging element 2100, or pixel, is a small region of the display unit imaging surface 130. In one embodiment of the present invention, a spatial imaging element 2100 displays wavelength- and time-division multiplexed imaging elements from both the left image data 11 and the right image data 12. A left-eye targeted light ray bundle 2101 is a light ray bundle, emitted from spatial imaging element 2100, which reaches left eye 15 after being transmitted through left-eye lens 2001. A right-eye targeted light ray bundle 2102 is a light ray bundle, emitted from spatial imaging element 2100, which reaches right eye 16 after being transmitted through right-eye lens 2002. The spectra, measured over the temporal integration time of the eye, of light ray bundles 2101 and 2102, before being transmitted through lenses 2001 and 2002, are exactly or substantially a superposition of two spectra, where the first spectrum is the spectrum of left-eye illumination 211 multiplied by left-eye illumination combiner transmission spectrum 1501 and the second spectrum is the spectrum of right-eye illumination 212 multiplied by right-eye illumination combiner transmission spectrum 1502. According to one possible solution, the left-eye lens 2001 has transmission spectrum 2401 ensuring that the regions, of the spectrum of left-eye targeted light ray bundle 2101, outside of the transmission bands of left-eye illumination combiner transmission spectrum 1501, are blocked or substantially blocked in left-eye lens 2001, thus blocking right image data 12 displayed at spatial imaging element 2100 from view of left eye 15, and thus transmitting through left-eye lens 2001 left image data 11 displayed at spatial imaging element 2100. Similarly, according to one possible solution, the right-eye lens 2002 has transmission spectrum 2402 ensuring that the regions, of the spectrum of right-eye targeted light ray bundle 2102, outside of the transmission bands of right-eye illumination combiner transmission spectrum 1502, are blocked or substantially blocked in right-eye lens 2002, thus blocking left image data 11 displayed at spatial imaging element 2100 from view of right eye 16, and thus transmitting through right-eye lens 2002 right image data 12 displayed at spatial imaging element 2100.

According to displays used with some embodiments of the present invention, the illumination combiner 203 has transmission spectra 1501 and 1502 that are spectrally complementary or substantially spectrally complementary and where the output illumination 213 of illumination combiner 203 has the same or substantially the same etendue as left-eye illumination 211 or right-eye illumination 212. In displays used with some embodiments of the present invention, this etendue is preserved or substantially preserved, even with no need for or substantially no need for guard bands between the cut-on/cut-off of pass bands in transmission spectrum 1501 and the cut-off/cut-on of neighboring pass bands in transmission spectrum 1502. Illumination combiner 203 may be of the type presented in prior art references (WO 2010/059453 A2, U.S. Pat. No. 3,497,283).

Embodiments of the present invention may also be used with displays that do not have an illumination combiner 203 in stereo illumination unit 101. Examples of such displays are filter-wheel based projection system displays (EP 1 830 585 A2) and transmissive displays of the backlit type (US 2007/0188711 A1). When used with displays not including an illumination combiner 203, transmission spectrum 1501 may be defined as filtering the display illumination used for displaying left image data 11 and transmission spectrum 1502 may be defined as filtering the display illumination used for displaying right image data 12.

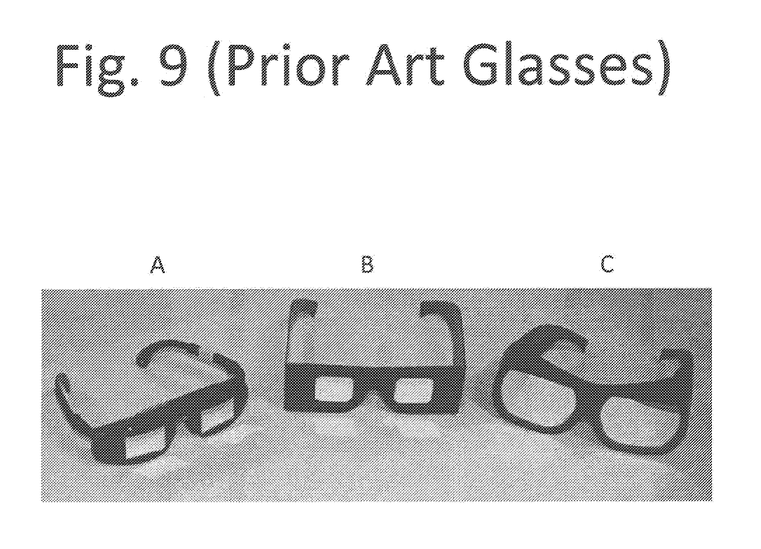

According to some embodiments of the present invention, the left-eye lens transmission spectrum 2401 is independent or substantially independent of the angle-of-incidence of the left-eye target light ray bundle 2101 to the left-eye lens 2001. In an embodiment of the present invention, the right-eye lens transmission spectrum 2402 is independent or substantially independent of the angle-of-incidence of the right-eye target light ray bundle 2102 to the right-eye lens 2002. This angle-independence is achieved by the left-eye lens 2001 and right-eye lens 2002 each including a lens assembly 2000. Lens assembly 2000 and its operation is illustrated in several figures and described in following paragraphs. The substantial angle-independence of the transmission spectrum of lens assembly 2000 results in no need for or substantially no need for guard bands between the cut-on/cut-off of pass bands in transmission spectrum 1501 and the cut-off/cut-on of neighboring pass bands in transmission spectrum 1502, and similarly the substantial angle-independence of the transmission spectrum of lens assembly 2000 results in no need for or substantially no need for guard bands between the cut-on/cut-off of pass bands in transmission spectrum 2401 and the cut-off/cut-on of neighboring pass bands in transmission spectrum 2402. Lens assembly 2000 has a transmission spectrum angle-independence that is superior to some prior art lenses used in glasses eyewear of the Infitec type illustrated in FIG. 9 described in WO2009/026888, EP1830585 and other references.

Returning to FIG. 7 the spectra have substantially evenly distributed pass bands with four pass bands in each transmission spectrum. Left-eye illumination combiner spectrum 1501 has pass bands in wavelength regions W1, W3, W5 and W7. Right-eye illumination combiner spectrum 1502 has pass bands in wavelength regions W2, W4, W6 and W8. In the exemplary embodiment in FIG. 7, transmission spectra 2401 and 2402 are similar to transmission spectra 1501 and 1502, with slight differences to take into account the small (compared to the prior art) angle-dependency, in lens assembly 2000, of the filter implementations of transmission spectra 2401 and 2402. Exemplary embodiments similar to the illustration in FIG. 7 are suitable for broad-spectrum LED illumination, narrow-spectrum LED illumination and broad-spectrum lamp illumination.

As discussed in the prior art (US 2008/0284982 A1), the use of more than three pass bands in transmission spectra 1501, 1502, 2401 or 2402 can enable a larger common color gamut for displaying of both left image data 11 and right image data 12.

An exemplary embodiment illustrated in FIG. 8 has three narrow pass bands in each of the left-eye illumination combiner transmission spectrum 1501 and right-eye illumination combiner transmission spectrum 1502. Transmission spectrum 1501 has pass bands in wavelength regions W1, W3 and W5. Transmission spectrum 1502 has pass bands in wavelength regions W2, W4 and W6. In the exemplary embodiment in FIG. 8, the left-eye lens transmission spectrum 2401 is a multi-notch filter with notches located in wavelength regions W2, W4 and W6, and the right-eye lens transmission spectrum 2402 is a multi-notch filter with notches located in wavelength regions W1, W3 and W5. Exemplary embodiments similar to the illustration in FIG. 8 are suitable for narrow-filtered broad-spectrum LED illumination, narrow-spectrum LED illumination, narrow-filtered broad-spectrum lamp illumination and laser illumination. Exemplary embodiments similar to that illustrated in FIG. 8 enable substantially clear viewing of off-screen objects, due to the high visible light transmission of the transmission spectra 2401 and 2402. By way of example, a visible light transmission of 75% is possible with narrowband RGB LED illumination, and visible light transmission of greater than 90% is possible with RGB laser illumination.

Narrow guard bands between the pass bands of left-eye illumination combiner transmission spectrum 1501 and the pass bands of right-eye illumination combiner transmission spectrum 1502 ensure that there is little or no stereo crosstalk, within the manufacturing tolerances of the filter implementations of spectra 1501, 1502, 2401 and 2402 and within the small angle-dependency, in lens assembly 2000, of the filter implementations of transmission spectra 2401 and 2402. By way of example, an angle-shift of less than 5 degrees is possible, for filter implementations in lens assembly 2000, for all viewing directions within ±30 degrees and for variations in interocular distance of ±10 mm and variations in focal point location of ±5 mm.

As an example, some of the above mentioned embodiments of filters 1501, 1502, 2401 and 2402 may be characterized as performing metameric wavelength-division multiplexing or metameric wavelength-division demultiplexing. Metamerism implies that two different spectra may have the same perceived color. In the case of metameric wavelength-division multiplexing, two substantially complementary spectra, each having the same or substantially the same color primaries, are combined. This principle, also in part discussed in the prior art (US 2008/0284982 A1, US 2007/0188711 A1), implies that stereoscopic wavelength-division multiplexing can be achieved with the same or substantially the same perceived on-screen and off-screen colors. The embodiments of the present invention are however not limited to including filters enabling metameric wavelength-division multiplexing.

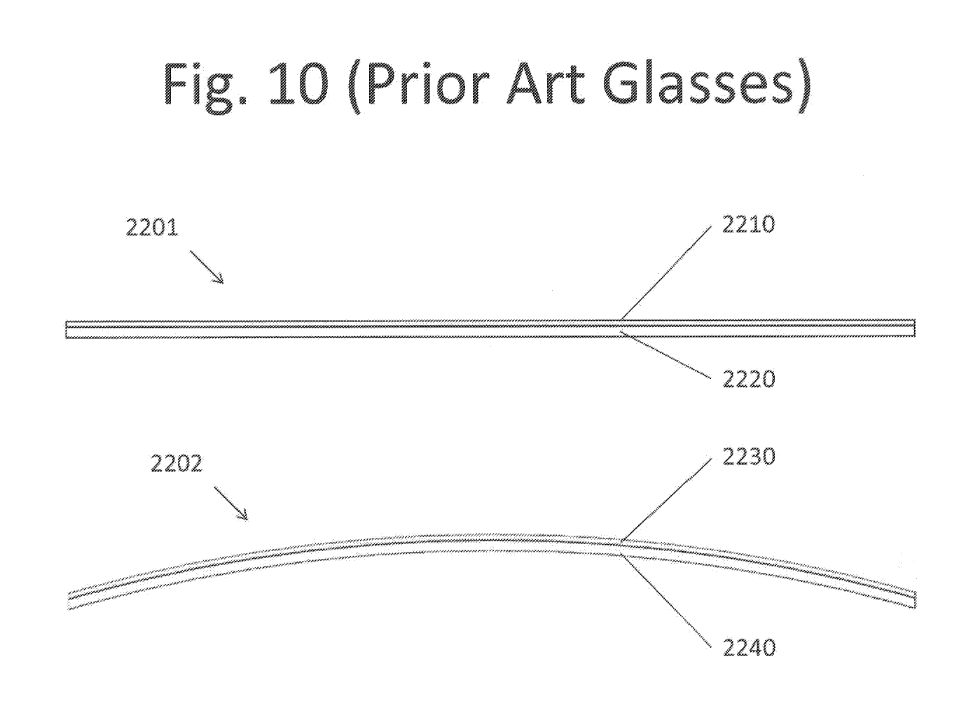

A photograph of prior art wavelength-division demultiplexing glasses for stereoscopic 3D display systems, using interference filters of the Infitec type, is shown in FIG. 9. These prior art glasses are of two main types: flat lens and curved lens. Flat lens glasses of the prior art are illustrated in the two leftmost glasses in FIG. 9, denoted by A and B. A pair of curved lens glasses of the prior art is illustrated in the rightmost glasses in FIG. 9, denoted by C. Due to the angle-sensitivity of the thin-film interference filters used in the prior art wavelength-demultiplexing glasses, flat lens glasses are most suited for glasses with a narrow field of view as shown in A and B in FIG. 9. Curved lens glasses, such as shown in C in FIG. 9, have an increased field of view. A schematic illustration of a radial cross-section of the lenses of the prior art glasses of both above-mentioned types is shown in FIG. 10. Glasses of the flat-lens type include a flat lens 2201 comprising a filter 2210 deposited on a flat filter substrate 2220. Said filter of the Infitec type is a thin-film interference filter, but may also be a rugate notch filter or holographic notch filter (US 2007/0247709 A1). The aforementioned filters are angle-sensitive with the transmission spectrum being shifted towards shorter wavelengths with increasing angle of incidence (AOI) to the filter, and the relative wavelength shift in percent is found by

$$Δ {λ}_{rel} = 100 ( 1 - \sqrt{1 - \frac{{sin}^{2} θ}{{n}^{* 2}}} ) ,$$

where θ is the AOI and n* is the effective refractive index. The effective refractive index of the filter is approximately the lowest refractive index or the refractive index of the lowest-index layer in the filter. For a typical multi-layer thin-film interference filter with SiO₂ as the lowest-index layer (refractive index 1.48 at 555 nm) the wavelength shift is approximately 1.5% for an AOI of 15 degrees, corresponding to a shift in the transmission spectrum of approximately 8.5 nm at 555 nm. Thus, for a field-of-view of 15 degrees, the filter 2210 in flat lens 2201 must have guard bands of at least 1.5% between each pass band of the left-eye transmission spectra and neighboring pass bands of the right-eye transmission spectra. For narrow-band illumination sources such as narrow-band LEDs, such a large guard band results in significant loss of brightness, with the loss of brightness increasing proportionally to the number of pass bands. Note that the relationship between AOI and relative wavelength shift is nonlinear, and for example reducing the AOI by a factor of 3 from 15 to 5 degrees results in a reduction in the relative wavelength shift by a factor of approximately 9 from approximately 1.5% to approximately 0.17%. It is thus obvious that it is desirable to reduce the AOI to the filters.

One way of reducing the AOI to the filters is to deposit said filters on a curved substrate. The curved lens 2202 of the prior art (US 2008/0278807 A1, US 2007/0236809 A1), illustrated in FIG. 32B, uses this approach. Glasses of the curved-lens type include a curved lens 2202 comprising a filter 2230 deposited on a curved filter substrate 2240. If curved lens 2202 has a radius of curvature equal to the distance from the eye center of rotation to said curved lens, the AOI of all viewable light rays is approximately 0 degrees. Thus, ideally this appears to be a good solution, although such ideal lenses may be ergonomically disadvantageous due to their large curvature and/or large size. The prior art (US 2007/0236809 A1) has solutions that enable cost-effective manufacturing of uniaxially curved lenses by roll-coated deposition of dielectric multilayer filters onto a flexible substrate. For more general biaxially-curved lenses, thin-film interference filters are deposited layer by layer, in deposition systems designed for flat substrates, in a manner that is subject to an effect called runoff. Runoff implies that the thickness of these layers is reduced with increasing curvature, and thus also reduces the optical path length through the filter with increasing curvature. Such a reduction in optical path length results in a relative wavelength shift towards shorter wavelengths. An exemplary runoff at the edge of curved lenses with 50 mm diameter, and radius of curvature of 120 mm, is 1.0%. An exemplary runoff at the edge of curved lenses with 50 mm diameter, and radius of curvature of 90 mm, is 1.5%. Thus, even with a perfect curved lens with 90 mm radius of curvature at a distance of 90 mm from the pupil of the eye, there is a substantial amount of wavelength shift in the transmission spectrum. In the prior art, the stereo cross-talk is required to be on the order of 0.5% or less to provide high-quality stereo image viewing, thus requiring many layers and costly filters. The need for a low amount of stereo cross-talk in the prior art is due to both left-eye and right-eye images being in focus when viewed through the eyewear lenses for both eyes. The above mentioned weaknesses of the prior art motivates for a new approach to designing lenses for wavelength-selective filtering in eyewear for stereoscopic 3D display systems.

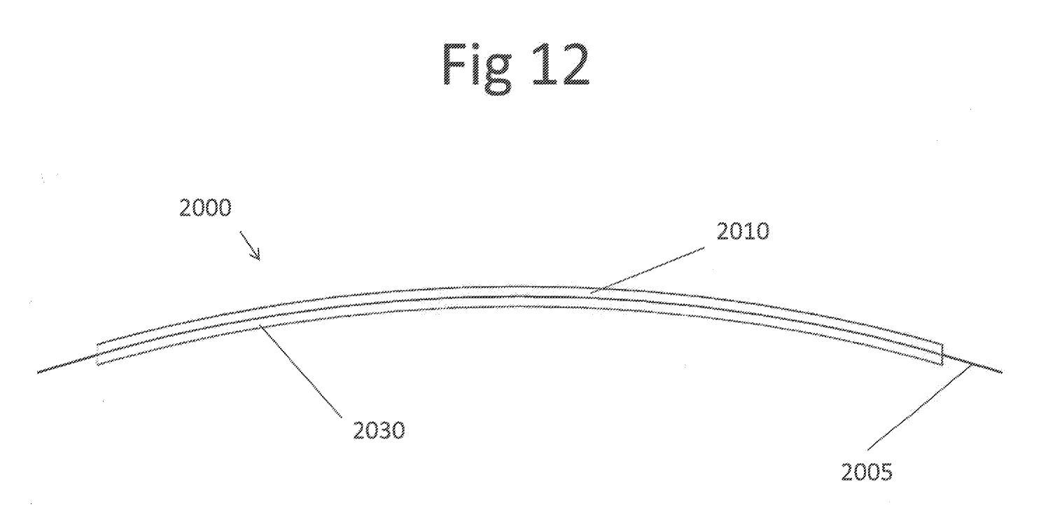

The viewing aid, according to some embodiments of the present invention, thus relates to a solution where the incident angle on the filter is adjusted so as to improve the filtering efficiency. According to one embodiment of the eyewear 14, the left-eye lens 2001 and right-eye lens 2002 both include a lens assembly 2000, said lens assembly being substantially flat, and said lens assembly comprising an outer optical assembly 2010 and an inner optical assembly 2030 as illustrated in FIG. 10. In the same figure, outer optical assembly 2010 and inner optical assembly 2030 are interfaced at geometrical surface 2005, with geometrical surface 2005 being planar in this embodiment. In an alternative embodiment of the eyewear 14, the left-eye lens 2001 and right-eye lens 2002 both include a lens assembly 2000, said lens assembly having a substantial curvature, and said lens assembly comprising an outer optical assembly 2010 and an inner optical assembly 2030 as illustrated in FIG. 12. In the same figure, outer optical assembly 2010 and inner optical assembly 2030 are interfaced at geometrical surface 2005, with geometrical surface 2005 having substantial curvature in this embodiment. In some embodiments of the present invention, the filter 2020 in embodiments of lens assembly 2000 included in left-eye lens 2001 has a transmission spectrum equal to or substantially similar to transmission spectrum 2401 of the left-eye lens 2001. In some embodiments of the present invention, the filter 2020 in embodiments of lens assembly 2000 included in right-eye lens 2002 has a transmission spectrum equal to or substantially similar to transmission spectrum 2402 of the right-eye lens 2002. In plain English, this means that the filter 2020 contributes the most to the shape of the transmission spectrum of lens assembly 2000, and that the remaining components in optical assemblies 2010 and 2030 are substantially clear in the visible spectrum.

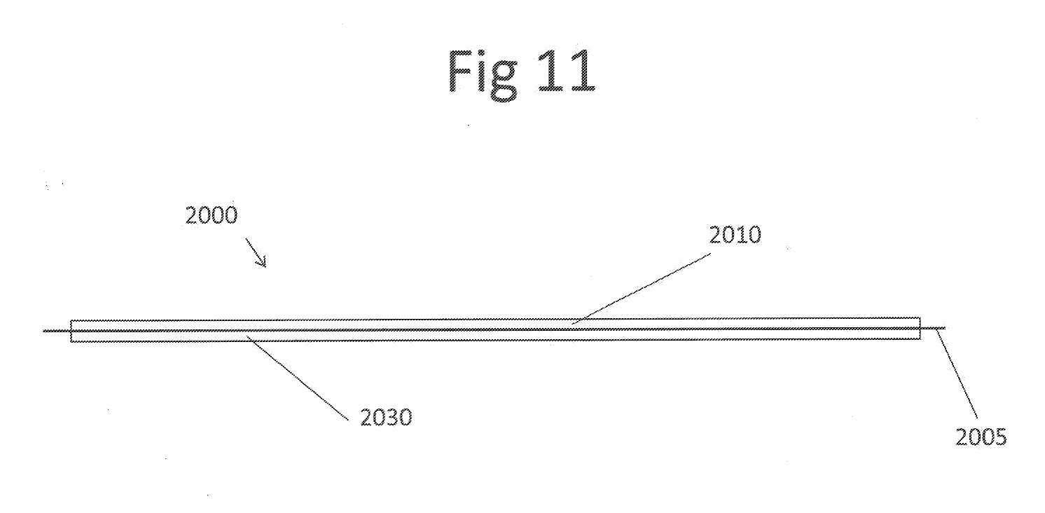

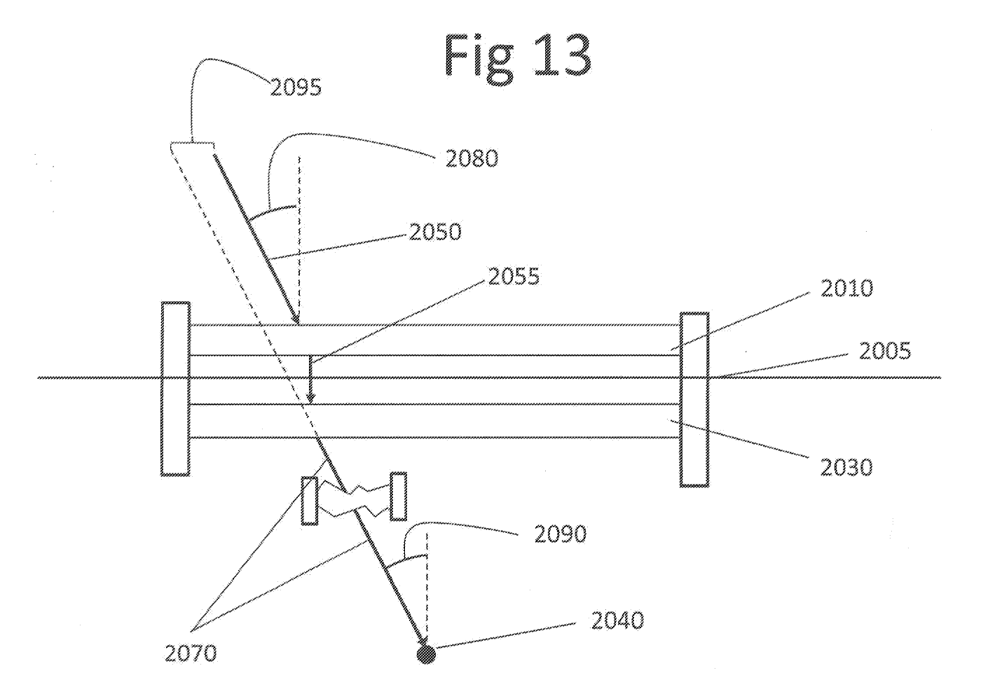

The operation of lens assembly 2000, is illustrated in FIG. 13 and in an illustration of the operation of an embodiment of lens assembly 2000 said figure is understood to be an illustration of an exploded view of a portion of a radial cross-section of substantially flat lens assembly 2000 illustrated in FIG. 11. In another embodiment, the operation of lens assembly 2000, is illustrated in FIG. 13 and in an illustration of the operation of an embodiment of lens assembly 2000 said figure is understood to be an illustration of an exploded view of a portion of a radial cross-section of substantially flat lens assembly 2000 illustrated in FIG. 12. The main purpose of said embodiments of lens assembly 2000 is to ensure that all or substantially all light rays that are transmitted from an imaging element 2100 on display unit imaging surface 130 through eye pupil 2040 of the viewer of the stereoscopic 3D display system 10 are transmitted through lens assembly 2000 free or substantially free from visible optical distortion and that all or substantially all such said light rays are transmitted through geometrical surface 2005 with an AOI equal to or substantially close to 0 degrees. An entry light ray 2050 originates from left-eye targeted light ray bundle 2101 or right-eye targeted light ray bundle 2102 illustrated in FIG. 6. By way of example, an entry light ray 2050 may have an angle-of-incidence to the outer optical assembly 2010 that differs from 0 degrees. In an illustration of the operation of an embodiment of the present invention, entry light ray 2050 has an entry light ray angle 2080 relative to a fixed normal vector, said ray enters outer optical assembly 2010, is transmitted through outer optical assembly 2010, exits optical assembly 2010 as corrected light ray 2055 with an AOI substantially normal to geometrical surface 2005, enters inner optical assembly 2030, is transmitted through inner optical assembly 2030, exits inner optical assembly as exit light ray 2070 with an exit light ray angle substantially the same as entry light ray angle 2080 and passes through or substantially near the eye pupil 2040. Exit light ray 2070 can be projected back in the direction from which entry light ray 2050 entered the lens assembly 2000, and the distortion offset 2095 can be found as the offset between the back-projected exit light ray 2070 and the entry light ray 2050. By way of example, the distortion offset 2095 can be minimized by minimizing the optical thickness of portions of the outer optical assembly 2010 and inner optical assembly 2030.

Lens assembly 2000 may be an afocal system in the case where the viewer of stereoscopic 3D display system 10 does not require vision correction or where said viewer is wearing vision-corrective eyewear or contact lenses. In a preferred embodiment of lens assembly 2000, inner optical assembly 2030 has a focal length of between 25 and 50 mm, outer optical assembly 2010 has a focal length of between −25 and −50 mm, and the focal lengths are chosen, depending on the distance between the two optical assemblies, such that the lens assembly 2000 is an afocal system with a magnification as close to 1 as possible.

Lens assembly 2000 may be a focal system in the case where the viewer of stereoscopic 3D display system 10 requires vision correction and said viewer is not wearing additional vision-corrective eyewear or contact lenses. In a preferred embodiment of lens assembly 2000, inner optical assembly 2030 has a focal length of between 25 and 50 mm, outer optical assembly 2010 has a focal length of between −25 and −50 mm, and the focal lengths are chosen, depending on the distance between the two optical assemblies, such that the lens assembly 2000 is an focal system providing vision correction, and with a magnification as close to 1 as possible.

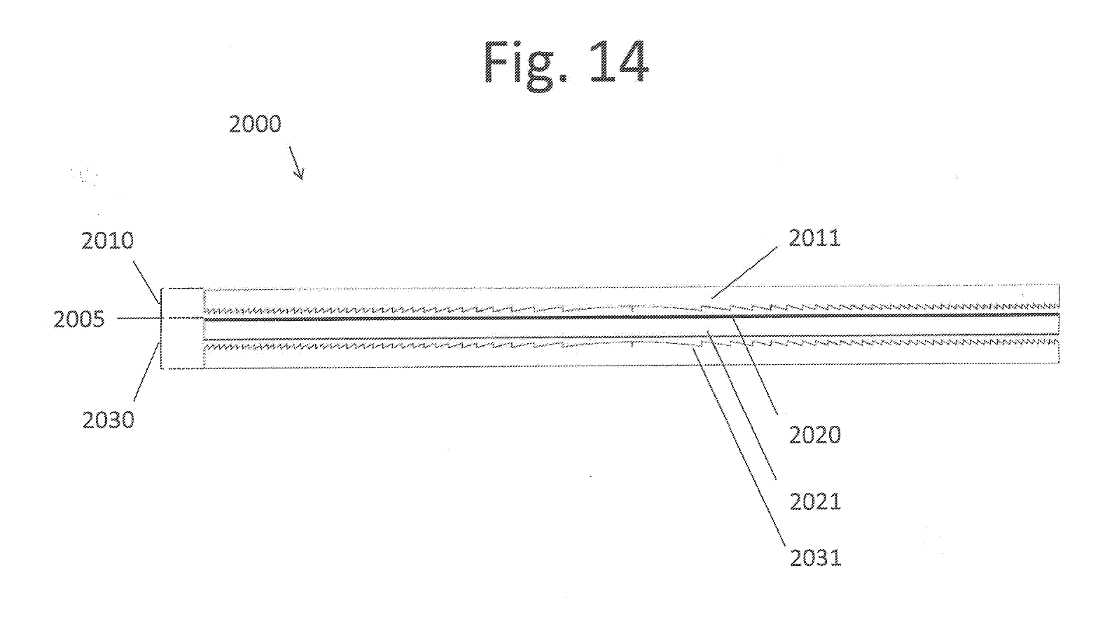

In an exemplary embodiment, of a substantially flat lens assembly 2000, illustrated in FIG. 14 and for illustrative purposes shown with exaggerated lens assembly thickness and Fresnel facet height, outer optical assembly 2010 includes a plano-concave outer Fresnel lens 2011 with the concave side nearer geometrical surface 2005, and inner optical assembly 2030 includes a filter 2020 placed on geometrical surface 2005, a filter substrate 2021 and a plano-convex inner Fresnel lens 2031 with the convex side nearer geometrical surface 2005, and the lens profile of the two said Fresnel lenses are substantially the same. By way of example, the two said Fresnel lenses can be designed such that, for a nominal inter-ocular distance and lens-to-eye distance, and over an entire field-of-view of 30 degrees for all entry light rays 2050 with a projected trajectory passing through the eye pupil 2040, the angle-of-incidence, of all corrected light rays 2055, to the filter 2020 is 0 degrees. By way of further example, the two said Fresnel lenses can be designed such that the AOI, of all corrected light rays 2055 to the filter 2020, is within ±5 degrees, for all viewing directions within ±30 degrees and for deviations from a nominal interocular distance of ±10 mm and deviations from a nominal lens-to-eye distance of ±5 mm. By way of example, this results in a maximum relative wavelength shift in the transmission spectra 2401 and 2402 of only 0.2% relative to the said transmission spectra at 0 degrees AOI.

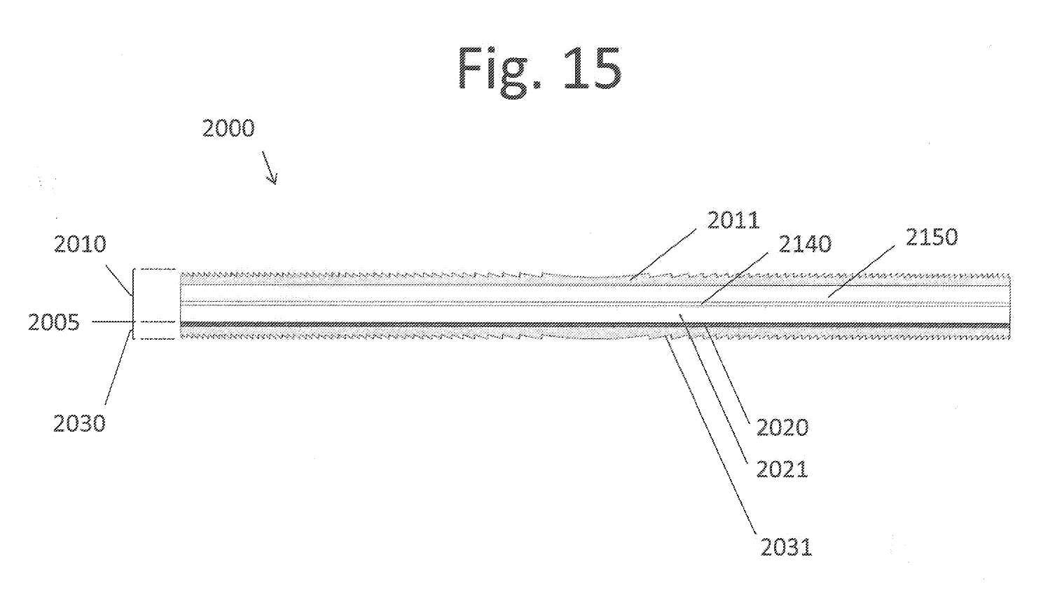

In an exemplary embodiment, of a substantially flat lens assembly 2000 of the present invention, illustrated in FIG. 15 and for illustrative purposes shown with exaggerated lens assembly thickness and Fresnel facet height, outer optical assembly 2010 includes a plano-concave outer Fresnel lens 2011 with the flat side nearer geometrical surface 2005, a substrate 2150 for outer Fresnel lens 2011, a low-index layer 2140, a filter 2020 placed on geometrical surface 2005, and filter substrate 2021. In said embodiment, inner optical assembly 2030 includes a plano-convex inner Fresnel lens 2031 with the flat side nearer filter 2020, and the lens profile of the two said Fresnel lenses are substantially the same.

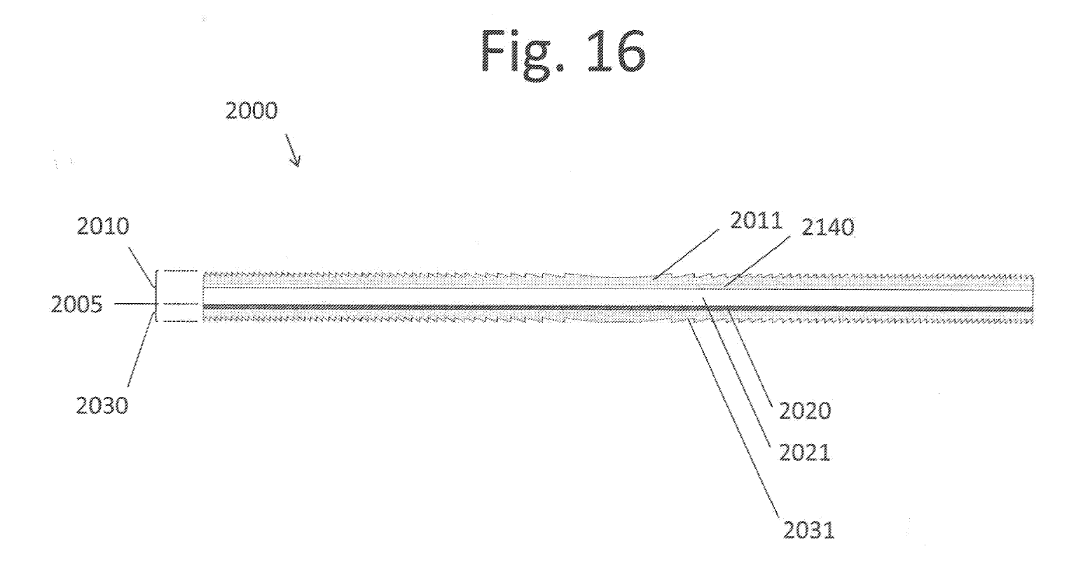

In an exemplary embodiment, of a substantially flat lens assembly 2000 of the present invention, illustrated in FIG. 16 and for illustrative purposes shown with exaggerated lens assembly thickness and Fresnel facet height, outer optical assembly 2010 includes a plano-concave outer Fresnel lens 2011 with the flat side nearer geometrical surface 2005, a low-index layer 2140, a filter 2020 placed on geometrical surface 2005, and filter substrate 2021. In said embodiment, inner optical assembly 2030 includes a plano-convex inner Fresnel lens 2031 with the flat side nearer filter 2020, and the lens profile of the two said Fresnel lenses are substantially the same.

In an embodiment of the lens assembly 2000 of the present invention, the function of low-index layer 2140 is to redirect light rays or light wave fronts by total or frustrated total internal reflection, where said light is incident on the shadow sides of the Fresnel facets, so as not to reach the pupil 2040. This function may, by way of example, reduce scatter or blur in the image perceived through lens assembly 2000 by ensuring that the operation of the Fresnel lens is as close as possible to the desired operation of an ideal lens.

By way of example, low-index layer 2140 may be an air gap, a low-index nanoporous coating, an ultrathin metal film operating around the percolation threshold, a low-index nanoneedle coating or a low-index optical metamaterial. By way of example, the refractive index of low-index layer 2140 may be chosen, depending on the refractive index of outer Fresnel lens 2011 or outer Fresnel lens substrate 2150, so as that all light incident on the draft side of the Fresnel lens facets is reflected by total internal reflection. By way of example, said Fresnel lens and substrate may have a refractive index of 1.6 and low-index layer 2140 may have a refractive index less than 1.25.

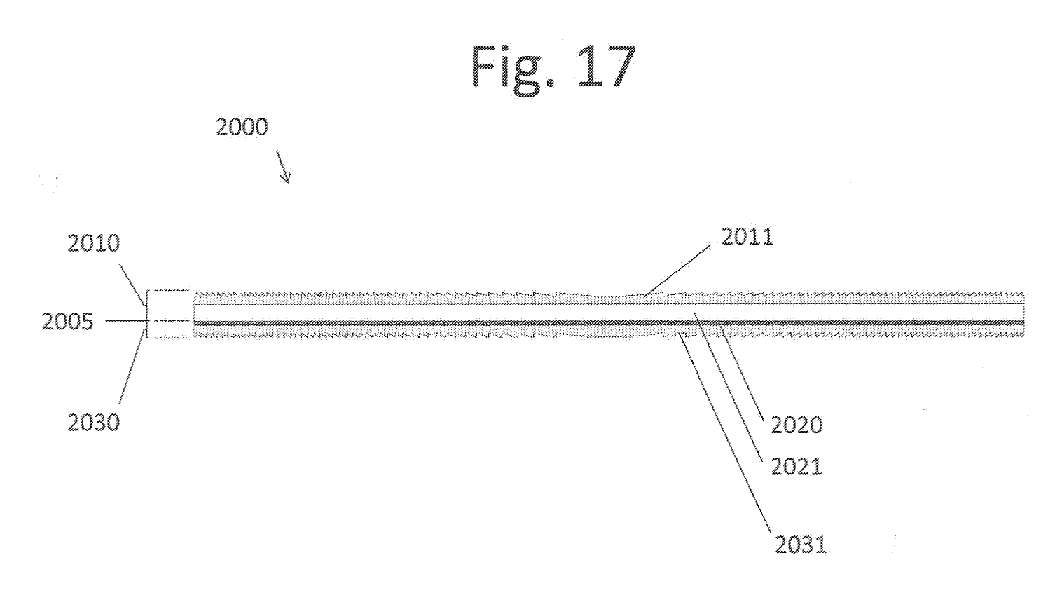

Lens assembly 2000 may also be manufactured without a low-index layer 2140, as illustrated in FIG. 17.

Embodiments of lens assembly 2000 of the curved type may be created similarly to the embodiments of lens assembly 2000 of the flat types illustrated in FIG. 14, FIG. 15, FIG. 16 or FIG. 17, by outer optical assembly 2010 and inner optical assembly 2030 both including a lens being smooth and curved on one side and similarly curved but faceted on the other side.

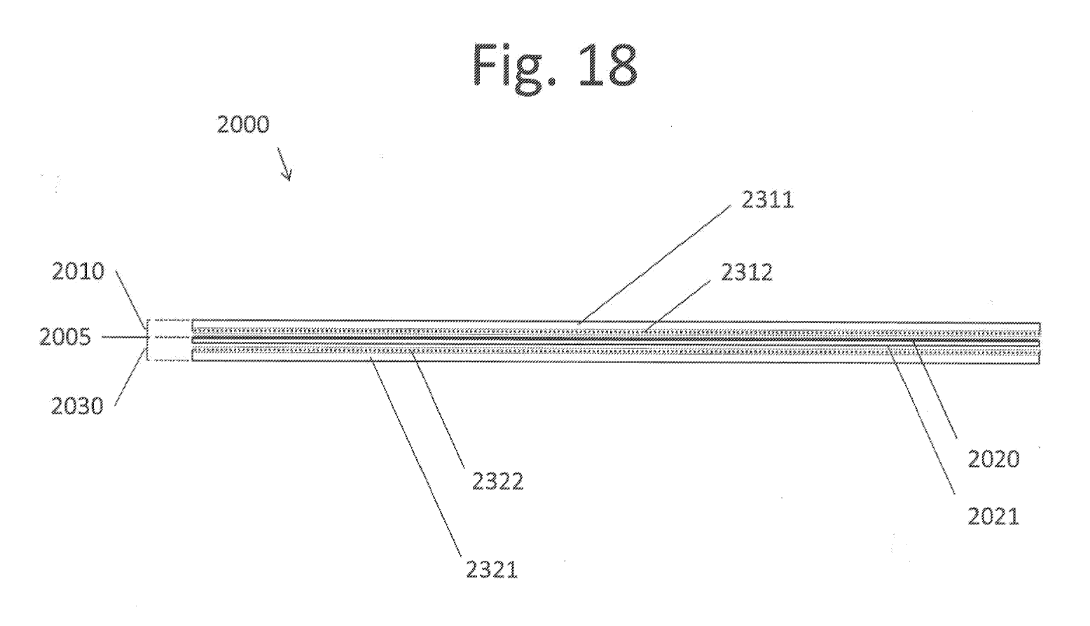

In an exemplary embodiment, of a substantially flat lens assembly 2000, illustrated in FIG. 18 and for illustrative purposes shown with exaggerated lens assembly thickness, outer optical assembly 2010 includes an outer lens solid 2311 and an outer diffractive surface 2312, and inner optical assembly 2030 includes an inner lens solid 2321, an inner diffractive surface 2322, a filter 2020 placed on geometrical surface 2005 and a filter substrate 2021. Said outer diffractive surface 2312 and inner diffractive surface 2322 are, in a preferred embodiment of the present invention, multi-order diffractive lenses (U.S. Pat. No. 5,589,982). In a preferred embodiment of lens assembly 2000 in left-eye lens 2001, the outer diffractive surface 2312 and inner diffractive surface 2322 are both multi-order diffractive lenses with their respective design wavelengths and diffraction orders chosen so as to provide a combined diffraction efficiency, for lens assembly 2000, that is high for wavelength regions corresponding to passbands in display filter 1501 and low for wavelength regions corresponding to passbands in display filter 1502. Similarly, for lens assembly 2000 in right-eye lens 2002, the outer diffractive surface 2312 and inner diffractive surface 2322 are both multi-order diffractive lenses with their respective design wavelengths and diffraction orders chosen so as to provide a combined diffraction efficiency, for lens assembly 2000, that is high for wavelength regions corresponding to passbands in display filter 1502 and low for wavelength regions corresponding to passbands in display filter 1501. In plain English, this means that the design wavelength and diffraction orders, of the left-eye and right-eye multi-order diffractive lens pairs, can be chosen so as to provide a focused left-eye image and a defocused right-eye image when viewing the display through the left-eye lens, and vice-versa for the other eye. The advantage of this is a lowered requirement on the stereo extinction ratio in the filters 2020, due to a reduction in the perceived stereo crosstalk when the opposite-eye image is viewed as a blurred out-of-focus image. A lower requirement on the stereo extinction ratio implies that fewer dielectric layers are required in filters 2020, thus reducing the cost of manufacturing these filters.

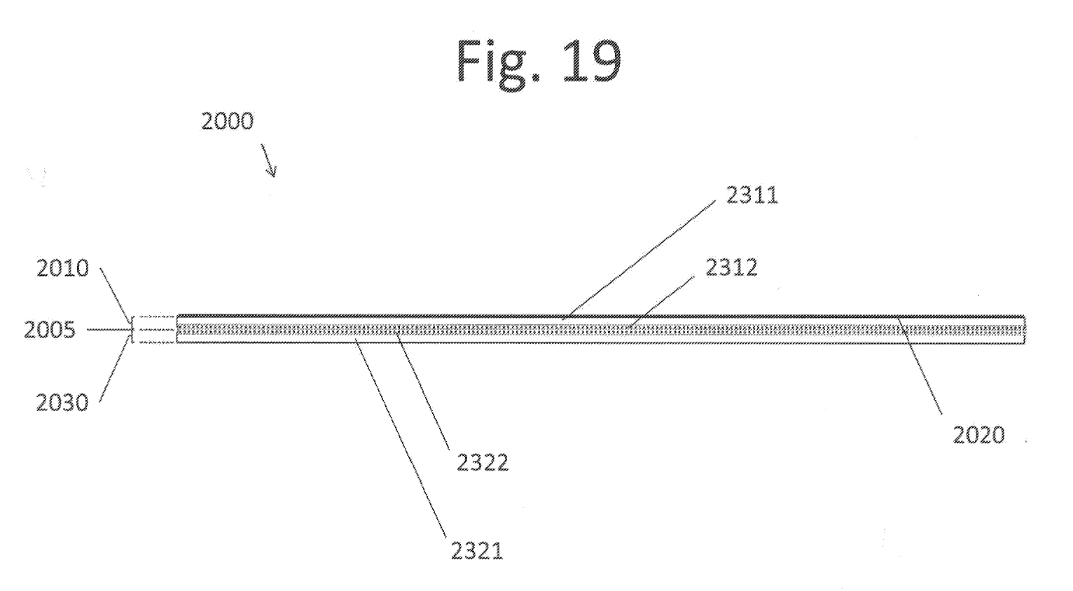

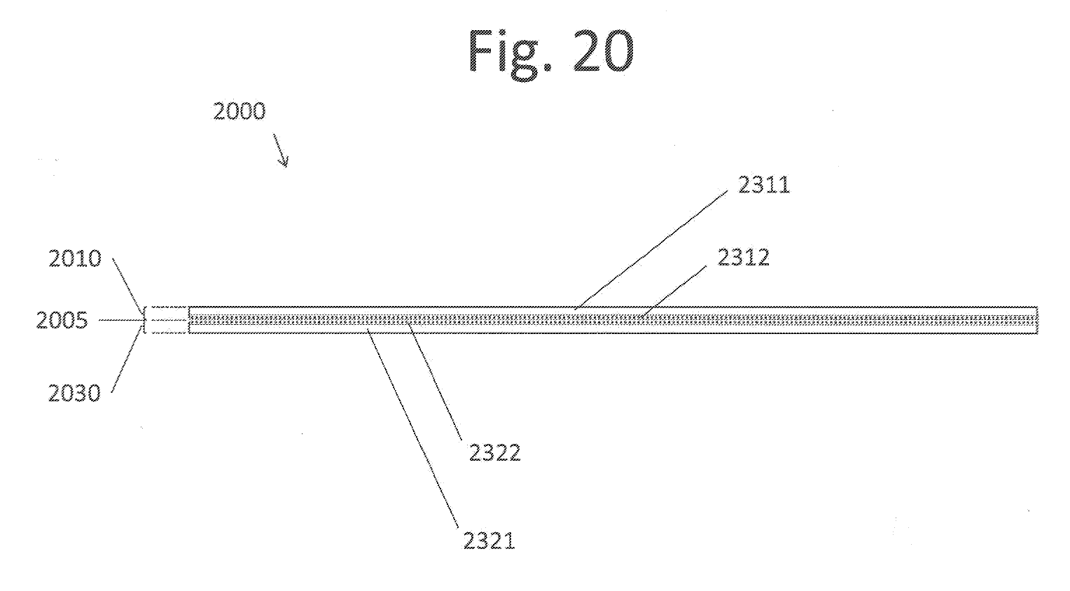

In an exemplary embodiment, of a substantially flat lens assembly 2000, illustrated in FIG. 19 and for illustrative purposes shown with exaggerated lens assembly thickness, outer optical assembly 2010 includes a filter 2020, an outer lens solid 2311 and an outer diffractive surface 2312, and inner optical assembly 2030 includes an inner lens solid 2321, and an inner diffractive surface 2322, with geometrical surface 2005 positioned between outer diffractive surface 2312 and inner diffractive surface 2322. Said outer diffractive surface 2312 and inner diffractive surface 2322 are, in a preferred embodiment of the present invention, multi-order diffractive lenses (U.S. Pat. No. 5,589,982). The exemplary embodiment in FIG. 20 makes use of the reduced stereo extinction requirements described in a previous paragraph. Reduced stereo extinction requirements, and the defocusing of the opposite-eye image, enables placement of filter 2020 on the outer surface of lens solid 2311, in applications where locally-reduced image contrast is acceptable, despite the angle-dependency of the transmission spectrum that results from this placement. The embodiment in FIG. 19 has fewer parts and is potentially thinner than the embodiment in FIG. 18, which might be an advantage in some applications.

In an exemplary embodiment, of a substantially flat lens assembly 2000, illustrated in FIG. 20 and for illustrative purposes shown with exaggerated lens assembly thickness, outer optical assembly 2010 includes an outer lens solid 2311 and an outer diffractive surface 2312, and inner optical assembly 2030 includes an inner lens solid 2321, and an inner diffractive surface 2322, with geometrical surface 2005 positioned between outer diffractive surface 2312 and inner diffractive surface 2322. Said outer diffractive surface 2312 and inner diffractive surface 2322 are, in a preferred embodiment of the present invention, multi-order diffractive lenses (U.S. Pat. No. 5,589,982). The exemplary embodiment in FIG. 20 makes use of the reduced stereo extinction requirements described in a previous paragraph. Reduced stereo extinction requirements, and the defocusing of the opposite-eye image, enables elimination of filter 2020 from lens assembly 2000, in applications where locally-reduced image contrast is acceptable. Compensation in left-eye image data 11 and right-eye image data 12, using known information about the optical transfer function of the compound lenses, in lens assemblies 2000 of left-eye lens 2001 and right-eye lens 2002, can be applied to improve the local image contrast. The embodiment in FIG. 20 has fewer parts and is potentially thinner than the embodiment in FIG. 18. A further advantage of the embodiment in FIG. 20 is the absence of a filter 2020, thus removing the cost of depositing multi-layer dielectric filters.

Embodiments of lens assembly 2000 of the curved type may be created similarly to the embodiments of lens assembly 2000 of the flat types illustrated in FIG. 18, FIG. 19, or FIG. 20, by outer optical assembly 2010 and inner optical assembly 2030 both including a lens solid being smooth and curved on one side and similarly curved but having a diffractive surface.

Someone knowledgeable in the field will understand that embodiments of the present invention are not limited to configurations illustrated in FIGS. 14-20, and there are additional possible embodiments of lens assembly 2000 comprising two lenses of opposite focal length, where said lenses may be diffractive or refractive. The choice of embodiments of the present invention may depend on factors such as the trade-off chosen between manufacturing complexity and image quality.

In an embodiment of lens assembly 2000 of the present invention, including refractive or diffractive lenses, said lenses can, by way of example, be manufactured using a process where a master mold created by diamond-turning, e-beam lithography or ion-beam lithography. By way of example, such a process may be injection molding, compression molding, hot embossing, or UV-embossing using UV-curable polymers. By way of example, said diffractive lenses may each be replicated in one monolithic piece in a material such as glass or acrylic, or replicated as a micro-structure onto a premade substrate such as glass or acrylic. By way of example, said lenses have a facet height of between 0.5 μm and 30 μm.

Someone knowledgeable in the field will understand that an embodiment of the present invention may include a lens assembly 2000 manufactured in other means than by diamond-turning or n-step lithography etching of a mold, and molding of flat diffractive or refractive lenses or curved diffractive or refractive lenses. By way of example, said lens assembly may include lenses with spatially varying index of refraction, spatially varying diffraction and said lenses may be created using gradient-index materials, optical metamaterials, and replication of nano-structured patterns or volumetric holographic elements

In a preferred embodiment of the stereoscopic 3D display system 10, the display unit 13 is a projection display and the stereo illumination unit 101 includes light-emitting diodes (LEDs) in left-eye illumination source 201 and right-eye illumination source 202 In a further variation of said embodiment, LEDs are narrow-band monochromatic LEDs. By way of example, said monochromatic LEDs are of the PT-120 type produced by Luminus Devices Ltd. An advantage of using narrow-band monochromatic LEDs is that it enables a large color gamut. A further advantage of using narrow-band monochromatic LEDs is that it enables the use of wavelength-selective filtering eyewear 14 with substantially clear glasses having a color-neutral photopically-weighted transmission of approximately 75%. Said clear glasses are enabled by left-eye illumination combiner transmission spectrum 1501, right-eye illumination combiner transmission spectrum 1502, left-eye lens transmission spectrum 2401 and right-eye lens transmission spectrum 2402 similar to said transmission spectra illustrated in FIG. 8.

In an embodiment of the stereoscopic 3D display system 10, the display unit 13 is a projection display and the stereo illumination unit 101 includes solid-state lasers in left-eye illumination source 201 and right-eye illumination source 202. By way of example, said solid-state lasers are solid-state semiconductor lasers. By way of example, said solid-state lasers are arrays of vertical extended cavity lasers (VECSELs) (U.S. Pat. No. 7,359,420 B2). The use of lasers enables a large color gamut further enables the use of wavelength-selective filtering eyewear 14 with substantially clear glasses having a color-neutral photopically-weighted transmission of greater than 90%. Said clear glasses are enabled by left-eye illumination combiner transmission spectrum 1501, right-eye illumination combiner transmission spectrum 1502, left-eye lens transmission spectrum 2401 and right-eye lens transmission spectrum 2402 similar to said transmission spectra illustrated in FIG. 8. By way of example, said transmission spectra are obtained using multi-band pass thin-film interference filters 1002, 1003 in spectral combiner 1000 and multi-notch thin-film interference filters in filter 2020 of lens assembly 2000 in left-eye lens 2001 and right-eye lens 2002. By way of another example, said transmission spectra 2401 and 2402 are obtained using rugate notch filters in filter 2020 of lens assembly 2000 in left-eye lens 2001 and right-eye lens 2002. By way of another example, said transmission spectra 2401 and 2402 are obtained using holographic notch filters in filter 2020 of lens assembly 2000 in left-eye lens 2001 and right-eye lens 2002. By way of example, an AOI of less than 5 degrees to the filters 2020, made possible by said lens assembly 2000, enables the use of advanced notch filters, with narrow notches, such as rugate notch filters and holographic notch filters.

In an embodiment of the stereoscopic 3D display system 10, the display unit 13 is a projection display and spatial light modulator(s) 103 is a single spatial light modulator capable of spatial modulation of illumination and said spatial modulation is insensitive or substantially insensitive to the polarization state of said illumination. By way of example, said single spatial light modulator is a digital micro-mirror device (DMD) of the type produced by Texas Instruments Ltd., left image data 11 and right image data 12 each include three color channels, and said single spatial light modulator modulates all three said color channels of both left image data 11 and right image data 12. Virtually flicker-free stereoscopic 3D display is possible by using LEDs in stereo illumination unit 101 and a DMD as a spatial light modulator 103 in display unit 13. By way of example, LEDs and solid-state semiconductor lasers have switching times of 1 microsecond. By way of example, DMDs modulate on the order of 30 000 binary frames per second.

In an embodiment of the stereoscopic 3D display system 10, the display unit 13 is a projection display and spatial light modulator(s) 103 is two or more spatial light modulators. By way of example, said spatial light modulators are a digital micro-mirror device (DMD) of the type produced by Texas Instruments Ltd.

In an embodiment of the stereoscopic 3D display system 10, the display unit 13 is a backlit transmissive display and the stereo illumination unit 101 includes light-emitting diodes (LEDs) in left-eye illumination source 201 and right-eye illumination source 202 and where said LEDs are a substantial source of the illumination in left-eye illumination 211 and right-eye illumination 212. In a variation of said embodiment, left-eye illumination source 201 emits left-eye illumination 211 including illumination perceived as red, illumination perceived as green and illumination perceived as blue. In a variation of said embodiment, right-eye illumination source 202 emits right-eye illumination 212 including illumination perceived as red, illumination perceived as green and illumination perceived as blue. In a further variation of said embodiment, LEDs are narrow-band monochromatic LEDs. By way of example, said monochromatic LEDs are of the PT-120 type produced by Luminus Devices Ltd. By way of example, the use of narrow-band monochromatic LEDs enables a large color gamut. By way of example, the use of narrow-band monochromatic LEDs enables the use of wavelength-demultiplexing eyewear 14 with substantially clear glasses having a color-neutral photopically-weighted transmission of greater than 75%. By way of example, said clear glasses are enabled by left-eye illumination combiner transmission spectrum 1501, right-eye illumination combiner transmission spectrum 1502, left-eye lens transmission spectrum 2401 and right-eye lens transmission spectrum 2402 similar to said transmission spectra illustrated in FIG. 8. By way of example, said transmission spectra are obtained using multi-bandpass thin-film interference filters 1002, 1003 in spectral combiner 1000 and multi-notch thin-film interference filters in filter 2020 of lens assembly 2000 in left-eye lens 2001 and right-eye lens 2002.

In an embodiment of the stereoscopic 3D display system 10, the display unit 13 is a backlit transmissive display and the stereo illumination unit 101 includes solid-state lasers in left-eye illumination source 201 and right-eye illumination source 202 and where said solid-state lasers are a substantial source of the illumination in left-eye illumination 211 and right-eye illumination 212. In a variation of said embodiment, left-eye illumination source 201 emits left-eye illumination 211 including illumination perceived as red, illumination perceived as green and illumination perceived as blue. In a variation of said embodiment, right-eye illumination source 202 emits right-eye illumination 212 including illumination perceived as red, illumination perceived as green and illumination perceived as blue. By way of example, said solid-state lasers are solid-state semiconductor lasers. By way of example, said solid-state lasers are arrays of vertical extended cavity lasers (VECSELs) (U.S. Pat. No. 7,359,420 B2). The use of lasers enables a large color gamut and further enables the use of wavelength-demultiplexing eyewear 14 with substantially clear glasses having a color-neutral photopically-weighted transmission of greater than 90%. By way of example, said clear glasses are enabled by left-eye illumination combiner transmission spectrum 1501, right-eye illumination combiner transmission spectrum 1502, left-eye lens transmission spectrum 2401 and right-eye lens transmission spectrum 2402 similar to said transmission spectra illustrated in FIG. 8. By way of example, said transmission spectra are obtained using multi-band pass thin-film interference filters 1002, 1003 in spectral combiner 1000 and multi-notch thin-film interference filters in filter 2020 of lens assembly 2000 in left-eye lens 2001 and right-eye lens 2002. By way of another example, said transmission spectra 2401 and 2402 are obtained using rugate notch filters in filter 2020 of lens assembly 2000 in left-eye lens 2001 and right-eye lens 2002. By way of another example, said transmission spectra 2401 and 2402 are obtained using holographic notch filters in filter 2020 of lens assembly 2000 in left-eye lens 2001 and right-eye lens 2002. By way of example, an AOI of less than 5 degrees to the filters 2020, made possible by said lens assembly 2000, enables the use of advanced notch filters, with narrow notches, such as rugate notch filters and holographic notch filters.

In an embodiment of the stereoscopic 3D display system 10, the display unit 13 is a transmissive display and transmissive display panel 113 is a transmissive display panel capable of spatial modulation of illumination and said spatial modulation is insensitive or substantially insensitive to the polarization state of said illumination. By way of example, said transmissive display panel is a MEMS-panel of the digital micro shutter (DMS) type produced by Pixtronix Inc., left image data 11 and right image data 12 each include three color channels, and said transmissive display panel modulates, in a field-sequential fashion, all three said color channels of both left image data 11 and right image data 12. Virtually flicker-free stereoscopic 3D display is possible by using LEDs or solid-state semiconductor lasers in stereo illumination unit 101 and a DMS-panel as transmissive display panel 113 in display unit 13. By way of example, LEDs and solid-state semiconductor lasers have switching times of 1 microsecond. By way of example, the micro shutters in DMS-panels have response times in the order of 100 microseconds. By way of example, display unit 13 includes one or more stereo illumination units 101 and backlight illumination optics 112 configured as an edge-lit backlighting unit (BLU), and by further way of example this BLU is a variation of the type described in (US 2008/0019147 A1) with modifications made to accommodate one or more stereo illumination units 101.

In an embodiment of the stereoscopic 3D display system 10, the display unit 13 is a transmissive display and transmissive display panel 113 is a transmissive display panel capable of spatial modulation of illumination and said spatial modulation is substantially only effective for illumination of one of two orthogonal polarization states. By way of example, said transmissive display panel is a thin-film transistor liquid crystal display (TFT-LCD) panel, left image data 11 and right image data 12 each include three color channels, and said transmissive display panel modulates, in a field-sequential fashion, all three said color channels of both left image data 11 and right image data 12. By way of example, said TFT-LCD panel has a field rate of at least 360 Hz, high enough to display at least 60 color stereo images per second. By way of example, display unit 13 includes one or more stereo illumination units 101 and backlight illumination optics 112 configured as an edge-lit backlighting unit (BLU), and by further way of example this BLU is a variation of the type described in (US 2008/0019147 A1) with modifications made to accommodate one or more stereo illumination units 101.

In an embodiment of the stereoscopic 3D display system 10, the display unit 13 is a transmissive display and transmissive display panel 113 is a transmissive display panel capable of spatial modulation of illumination and said spatial modulation is substantially only effective for illumination of one of two orthogonal polarization states. By way of example, said transmissive display panel is a thin-film transistor liquid crystal display (TFT-LCD) panel, left image data 11 and right image data 12 each include three color channels, said transmissive display simultaneously displays all three color channels, and said transmissive display panel modulates, in a field-sequential fashion, left image data 11 and right image data 12. By way of example, said TFT-LCD panel has a field rate of at least 120 Hz, high enough to display at least 60 color stereo images per second. By way of example, display unit 13 includes one or more stereo illumination units 101 and backlight illumination optics 112 configured as an edge-lit backlighting unit (BLU), and by further way of example this BLU is a variation of the type described in (US 2008/0019147 A1) with modifications made to accommodate one or more stereo illumination units 101. The possibility of pulsing LEDs at a substantially high brightness, during shorter duty cycles, enables a LED- or laser-illuminated stereoscopic 3D backlit transmissive 3-color TFT-LCD display of the present invention, using stereo illumination unit 101, to have a substantially higher brightness than a similar LED- or laser-illuminated stereoscopic 3D displays using liquid crystal shutter glasses or switchable polarization rotators.

In a preferred embodiment of the present invention, where the display unit 13 is a transmissive display including one or more stereo illumination units 101, the backlight illumination optics 112 is of the edge-lit type similar to that described in reference US 2010/0014027 A1. Referring to this reference let AXXX denote the numbered items in said reference. In said preferred embodiment, the edge illuminator numbered A101 has input illumination A401 originating from one stereo illumination unit 101 and input illumination A402 originating from another stereo illumination unit 101. The advantage of said preferred embodiment, as compared to edge-lit embodiments in WO 2009/026888 A1, is that stereo illumination unit 101 couples the left-eye illumination 211 and right-eye illumination 212 into substantially the same optical path, thus preserving etendue and doubling the amount of illumination within a given acceptance angle as compared to WO 2009/026888 A1.

In a preferred embodiment of the present invention, where the display unit 13 is a transmissive display including one or more stereo illumination units 101, the backlight illumination optics 112 is of the edge-lit type similar to that described in reference US 2008/0019147 A1. Referring to this reference let BXXX denote the numbered items in said reference. In said preferred embodiment, locations in the LCD system B3, containing LEDs B6 include LED-illuminated stereo illumination combiners 101.

An advantage of edge-lit backlighting units is the relative simplicity and low cost. If cost issues can be resolved, an embodiment of the present invention may include a display unit 13 of the transmissive display type, where backlight illumination optics 112 is of the direct-lit type including a large number of stereo illumination units 101. The advantage of this approach, compared to the prior art described in referenced article “Interference-Filter-Based Stereoscopic 3D LCD” is the increased brightness and illumination uniformity due to the coupling of left-eye illumination 211 and right-eye illumination 212 into substantially the same optical path, thereby preserving etendue. The advantage of direct-lit backlighting, well known in the prior art, is the possibility of very high static constrast ratios obtained by local dimming. Displays with edge-lit backlighting units typically have a static contrast ratio limited by the contrast ratio of the transmissive display panel.

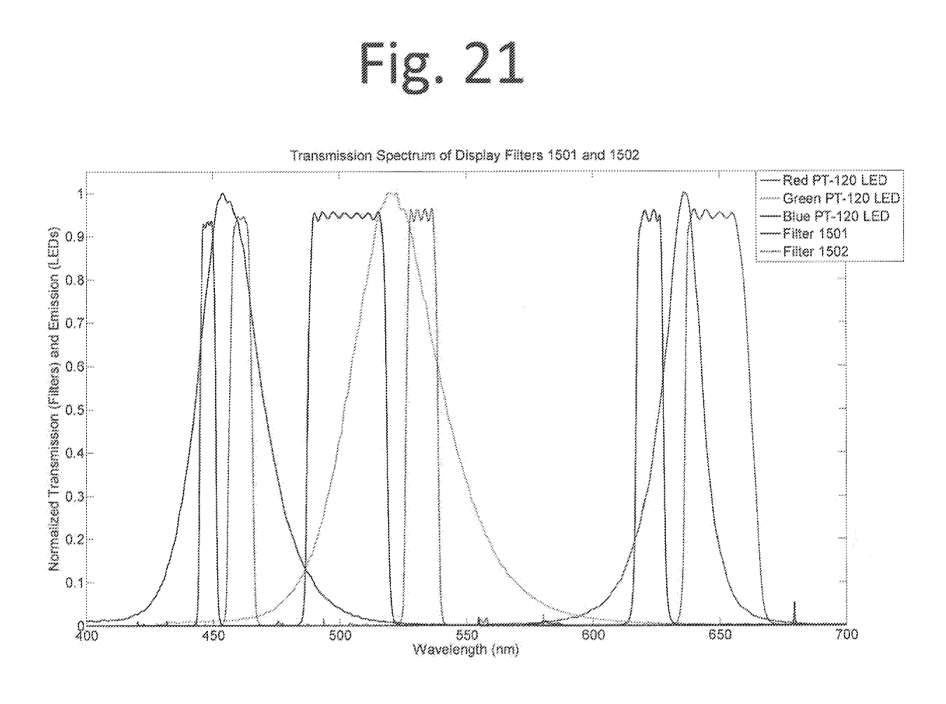

### Example Filter and Diffractive Lens Set—FIGS. 21-25

This example filter set is intended for use with narrow-band RGB LEDs, and is optimized to provide a high visible light transmission in color-neutral glasses while still having a large stereo color gamut. This filter set has three pass bands in the left-eye display filter, three pass bands in the right-eye display filter, four pass bands in the left-eye eyewear filter and four pass bands in the right-eye eyewear filter. This filter set is illustrated by actual interference filter designs.

The transmission spectra of the left-eye display filter 1501 and right-eye display filter 1502 are shown in FIG. 21, together with the emission spectra of red, green and blue PT-120 LEDs (Luminus Devices Inc., MA, USA). Filters 1501 and 1502 both have three pass bands.

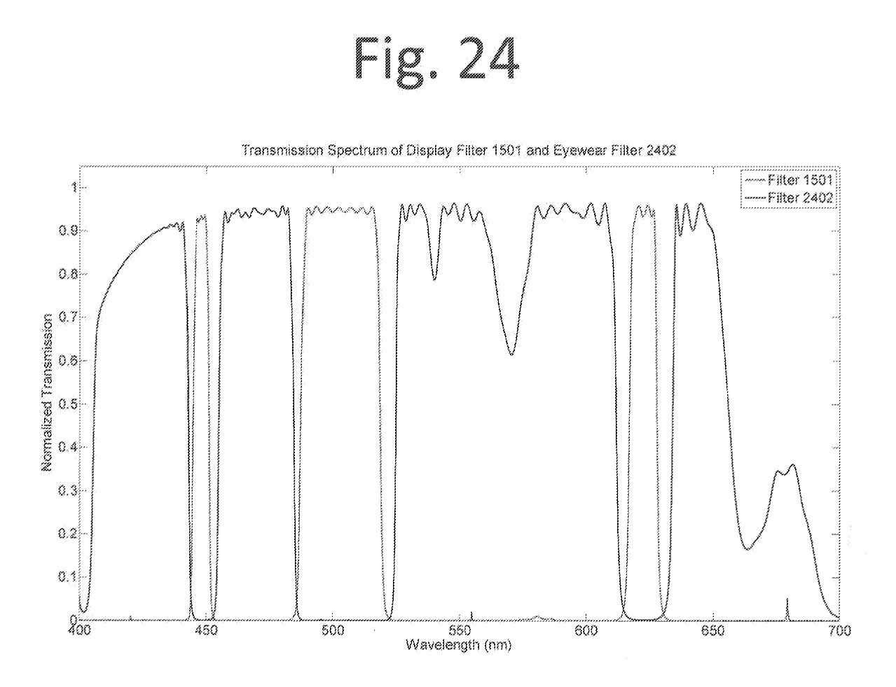

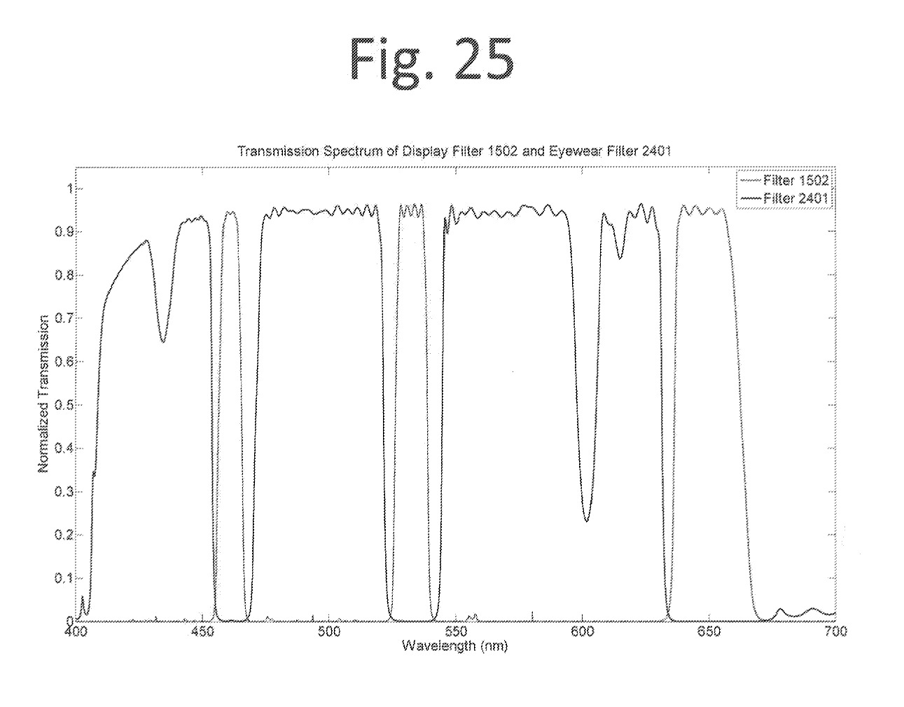

The transmission spectra of the left-eye display filter 1501 and right-eye eyewear filter 2402 are illustrated in FIG. 24. Eyewear filter 2402 is a triple-notch filter with four pass bands. The transmission spectra, of right-eye display filter 1502 and left-eye eyewear filter 2401, are illustrated in FIG. 25. Eyewear filter 2401 is a quadruple-notch filter with four pass bands, where three of the notches block the pass bands of display filter 1502 and one notch attenuates an emission peak in fluorescent illuminants.

The left-eye color gamut is substantially similar to the right-eye color gamut. A small amount of color correction is needed, and the relative luminances of the color primaries are between 20-25%, resulting in a stereo lumens efficiency after color correction of approximately 10%. The filter set is designed to have an absence of substantial color distortions. Regardless of illuminant, the visible light transmission is approximately 70±10% for all three tristimulus values. These eyewear filters enable clear viewing of off-screen objects with no substantial color distortions.

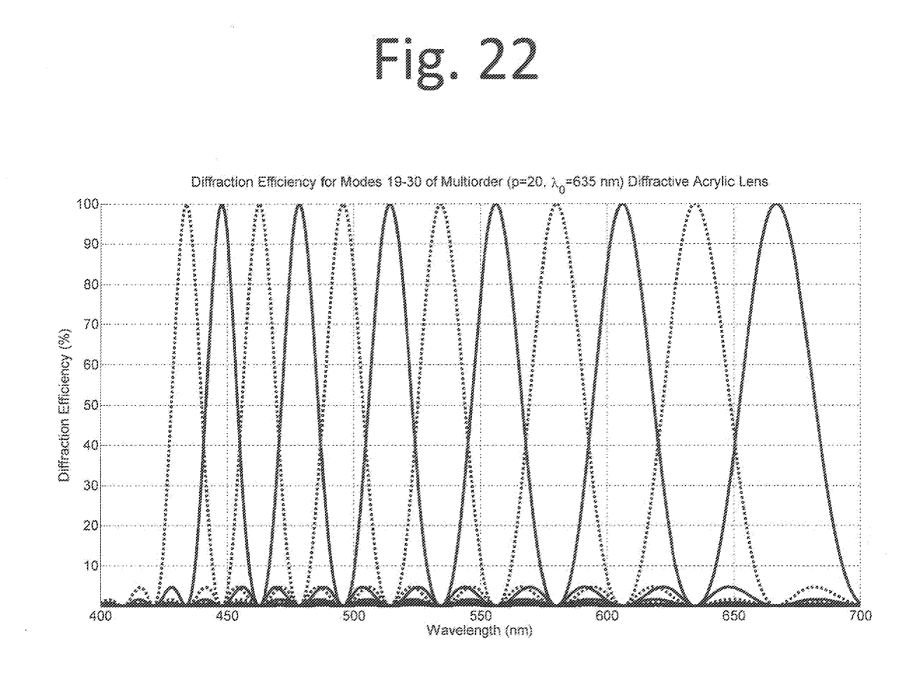

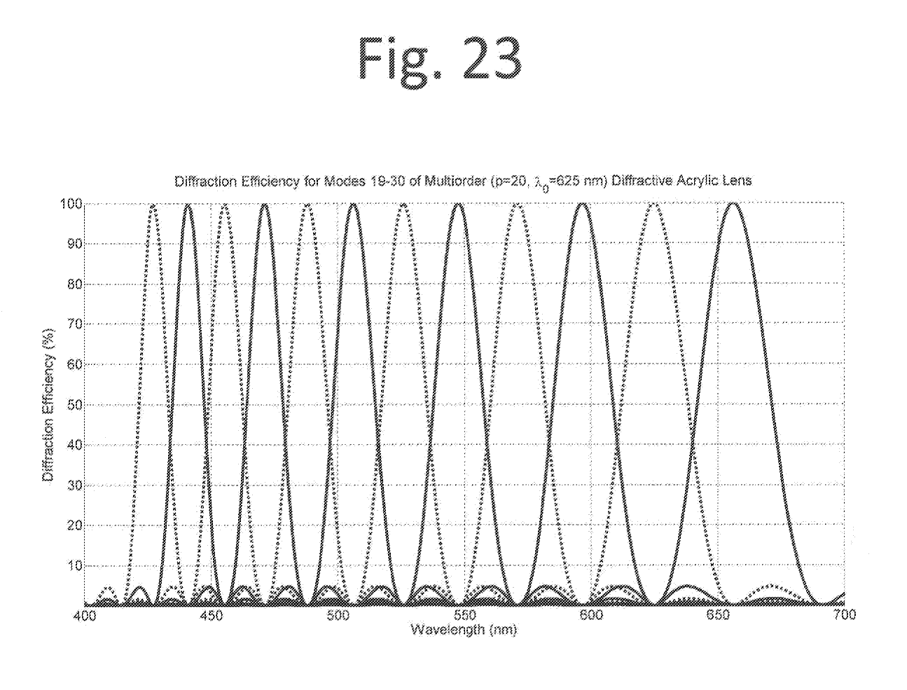

FIG. 22 shows the diffraction efficiency of an exemplary embodiment of a multi-order diffractive lens for use in lens assembly 2000 in left-eye lens 2001. The diffraction efficiency is near unity for all passbands in left-eye display filter transmission spectrum 1501, and substantially reduced for all passbands in right-eye display filter transmission spectrum 1502. FIG. 23 shows the diffraction efficiency of an exemplary embodiment of a multi-order diffractive lens for use in lens assembly 2000 in right-eye lens 2002. The diffraction efficiency is near unity for all passbands in right-eye display filter transmission spectrum 1502, and substantially reduced for all passbands in left-eye display filter transmission spectrum 1501. In plain English, this means that the design wavelength and diffraction orders, of the left-eye and right-eye multi-order diffractive lens pairs, can be chosen so as to provide a focused left-eye image and a defocused right-eye image when viewing the display through the left-eye lens, and vice-versa for the other eye.

A disadvantage of the glasses filters 2401 and 2402, of the example filter set illustrated in FIG. 24 and FIG. 25, is the complexity of designing notch filters with high extinction ratio. By utilizing the a lowered requirement on the stereo extinction ratio in the filters 2020, due to a reduction in the perceived stereo crosstalk when the opposite-eye image is viewed as a blurred out-of-focus image, fewer dielectric layers are required in filters 2020 to obtain a satisfactory image quality, thus reducing the cost of manufacturing these filters. It is also understood, that in some embodiments of the present invention, the combination of the filtering means in the display, illustrated by display filter left-eye transmission spectrum 1501 and right-eye transmission spectrum 1502, and diffractive filtering means in the viewing aid, illustrated by multi-order diffractive lens diffraction efficiencies in FIG. 22 and FIG. 23, is sufficient to provide an acceptable stereoscopic image without the use of relatively costly dielectric multi-layer filters in the viewing aid. Thus, there is the possibility for both high-end and regular glasses for use with the same display filters.

### Other Displays

Someone knowledgeable in the field will understand that the present invention may include display units 13 of types other than imaging projection display of FIG. 2 or transmissive flat-panel displays of FIG. 3. By way of example, display unit 13 may be a of the holographic image projection type, including spatial light modulators that spatially modulate the phase of laser illumination, or both the phase and the magnitude of the laser illumination, and in said example there may be holographic projection optics that perform a Fourier transform of the phase and/or magnitude of the laser illumination spatially modulated by said spatial light modulators, so as to project said Fourier-transformed spatially-modulated laser illumination onto a viewable display surface. By way of example, said spatial light modulator(s) may be a 1D array of phase-modulating elements and a scanning device, similar to a grating light valve (GLV) but operating in a uniaxial holographic image projection mode, whereby the GLV MEMS modulates the position or state of its array elements in such a way that the Fourier transform, of laser illumination having its phase modulated by the 1D array, is equal to or substantially equal to a vertical or horizontal scan line of left image 11 or right image 12. By way of example, said scanning device may be a mechanically rotating mirror, an oscillating resonant-mode MEMS mirror or a solid-state holographic scanning device with associated optics. By way of example, said solid-state holographic scanning device may include a second 1D array for phase modulation of laser illumination. By way of example, said spatial light modulator(s) may be 2D ferroelectric liquid crystal on silicon (FLCOS) microdisplay(s) modulating the phase of laser illumination, similar to the system developed by Light Blue Optics Ltd. By way of example, said spatial light modulator(s) may be 2D phase-modulating MEMS microdisplay, similar to the microdisplay(s) currently applied e.g. to adaptive optics systems in telescopes.

Thus to summarize, the invention relates to a stereoscopic viewing aid for viewing images received from a stereoscopic imaging system, the imaging system comprising two channels providing images having two different sets of wavelength ranges. The viewing aid comprising two filtering means, one for each eye, the first transmitting light within the first set of wavelengths and the second transmitting light within the second set of wavelengths representing the images of the two stereoscopic channels. Each of the filtering means comprises a first optical device or assembly 2010, 2011, 2013, 2312 having a predetermined focal length at the corresponding wavelengths so as to change the incident angle of the light from the imaging system relative to a surface of the viewing aid 2005. This surface may be curved or constitute a plane surface.

Preferably the focal length is negative so as to reduce the incident angle and thus also reduce the difference in direction of light from the different parts of the imaging system. This is especially advantageous if the filtering means comprises a dielectric filter 2020 transmitting light within one of said sets of wavelengths positioned after said first optical device so that said optical device reduces the angle of incident on said filter, thus also reducing the variation in the wavelength of the filtered light.

Preferably the first optical device is a first lens on the first surface for decreasing the angle between the light from the imaging system onto a filter, and the second optical device or assembly 2030 surface being provided with a second lens 2031,2322 for essentially re-establishing the direction of the incoming light from the imaging system. In this embodiment, the first and first and second lenses are preferably constituted by Fresnel lenses 2011, 2031, but diffractive and refractive lenses are also possible, as well as combinations of such. The first and second lenses combined may constitute an afocal system.

According to one embodiment the first and second lenses combined are a focal system providing vision correction, so that a user may have specially designed 3D-glasses compatible to their eyes, thus eliminating the need for simultaneous use of two sets of viewing aids when watching the 3D images.

The first optical device/assembly 2010 may alternatively be provided with a first diffractive filter 2312 having a focal length within one of said sets of wavelengths while scattering light outside said set of wavelengths or diffusing the light outside the selected wavelengths. This way a filtering of said light is obtained without a dielectric filter between the lenses. Preferably this system also comprises a second optical device constituted by a second diffractive surface 2322 for essentially re-establishing the direction of the incoming light within said range of wavelengths from the imaging system. This system may also include a course dielectric filter removing most, although not all, of the light, thus reducing the requirements of the diffractive filter or dielectric filter.

As stated above, if two optical devices are used they may have opposite focal lengths or the combined focal length may be selected so as to match the eye of the individual user.

### LIST OF REFERENCES

| | |
|---|---|
| US 2008/0019147 A1 | LED Color Management and Display Systems |
| US 2010/0014027 A1 | LED Backlight having Edge Illuminator for |
| | Flat Panel LCD Displays |
| U.S. Pat. No. | Manufacturable Vertical Extended Cavity Surface |
| 7,359,420 B2 | Emitting Laser Arrays |
| EP 1 830 585 A2 | Method and Device for Performing Stereoscopic |
| | Image Display Based on Color Selective Filters |
| U.S. Pat. No. | Device for Projecting a Color Image |
| 6,698,890 B1 | |
| U.S. Pat. No. | Device for Projecting a Stereo Color Image |
| 7,001,021 B2 | |
| WO 1998/049837 A1 | Method and Facility for Light-Beam Projection |
| | of Images on a Screen |
| WO 2000/074392 A1 | Device for Projecting a Colour Image |
| WO 2004/038457 A2 | Stereo Projection System and Projection |
| | Device Therefor |
| WO 2008/061511 A1 | Stereo Projection with Interference Filters |
| WO 2009/026888 A1 | System for Reproducing Stereographic Images |
| WO 2010/059453 A2 | High Durability Color Combiner |
| U.S. Pat. No. | Color Selection Polarizing Beam Splitter |
| 3,497,283 | |
| US 2007/0188711 A1 | Multi-Functional Active Matrix Liquid |
| | Crystal Displays |
| US 2008/0284982 A1 | Spectral Separation Filters for 3D |
| | Stereoscopic D-Cinema Presentation |
| US 2008/0278807 A1 | Method and System for Shaped Glasses |
| | and Viewing 3D Images |
| US 2007/0236809 A1 | Forming Spectral Filters |
| DE 199 24 167 A 1 | VerfahrenzurAufzeichnung and Wiedergabe |
| | von FarbbildenmitgestigerterWiedergabetreue |
| US 2007/0247709 A1 | 3-D Projection Full Color Multimedia Display |
| LED-Based 3D | 2008 LED Projection Systems Report, Section |
| | 4.8.4. LED-Based 3D |
| Displays with Infitec | Displays with Infitec Technology, Insight |
| Technology | Media LLC., October 2008. |
| Interference-Filter- | Interference-Filter-Based Stereoscopic 3D LCD, |
| | A. Simon, M. G. Prager, |
| Based Stereoscopic 3D | S. Schwarz, M. Fritz, and H. Jorke, Journal |
| | of Information |
| LCD | Display, Vol. 11, No. 1, March 2010. |
| U.S. Pat. No. | Polychromatic Diffractive Lens |
| 5,589,982 | |
| Polychromatic | Spectral Properties of Multiorder Diffractive |
| | Lenses, |
| Multiorder Diffractive | Dean Faklis and G. Michael Morris, |
| Lens | APPLIED OPTICS, Vol. 34, No. 14, 10 May |
| | 1995, Optical Society of America. |

1. A stereoscopic viewing aid for viewing images received from a stereoscopic imaging system, the imaging system comprising two channels providing images having two different sets of wavelength ranges, the viewing aid comprising:
two filtering means, the first transmitting light within the first set of wavelengths and the second transmitting light within the second set of wavelengths, each of said filtering means comprising a first optical device having a selected focal length at the corresponding wavelengths, and the filtering means comprises a dielectric filter transmitting light within one of said sets of wavelengths positioned after said first optical device, the first optical device having a negative focal length so that it reduces the angle of incidence on said filter, wherein the viewing aid also comprises a second optical device having a positive focal length on the opposite side of each filtering means.

2. The stereoscopic viewing aid according to claim 1, wherein the first optical device is a first lens on the first surface for collimating light from the imaging system so as to decrease the angle between the light from the imaging system onto a filter, and the second filter surface being provided with a second lens for essentially re-establishing the direction of the incoming light from the imaging system.

3. The stereoscopic viewing aid according to claim 1, wherein said first and second lenses are constituted by Fresnel lenses.

4. The stereoscopic viewing aid according to claim 1, wherein said first and second lenses are diffractive lenses.

5. The stereoscopic viewing aid according to claim 1, wherein said first and second lenses combined are an afocal system.

6. The stereoscopic viewing aid according to claim 1, wherein said first and second lenses combined are a focal system providing vision correction.

7. The stereoscopic viewing aid according to claim 1, wherein one of said optical devices is a diffractive filter having said selected focal length only within one of said sets of wavelengths.

8. The stereoscopic viewing aid according to claim 8, comprising a second optical device for essentially re-establishing the direction of the incoming light within said range of wavelengths from the imaging system.

9. The stereoscopic viewing aid according to claim 8, comprising an additional filter.

10. The stereoscopic viewing according to claim 1, wherein said two optical devices have opposite focal lengths at said sets of wavelengths.

11. A stereoscopic viewing aid for viewing images received from a stereoscopic imaging system, the imaging system comprising two channels providing images having two different sets of wavelength ranges, the viewing aid comprising:
two filtering means, the first transmitting light within the first set of wavelengths and the second transmitting light within the second set of wavelengths, each of said filtering means being constituted by a diffractive lens having said selected focal length only in the corresponding set of wavelengths.

12. The stereoscopic viewing aid according to claim 11, wherein each filtering means is provided with a second lens having a second focal length.

13. The stereoscopic viewing aid according to claim 12, wherein the second lens has a focal length being opposite of said diffractive lens.

14. The stereoscopic viewing aid according to claim 12, wherein said second lens is a diffractive lens having a selected focal length only within the corresponding set of wavelengths.
